(19) United States
(12) Patent Application Publication
(10) Pub. No.: US 2009/0226872 A1
(43) Pub. Date: Sep. 10, 2009

(54) ELECTRONIC GRADING SYSTEM

(76) Inventor: Nicholas Langdon Gunther, Stamford, CT (US)

Correspondence Address: Nicholas L. Gunther, 492 June Road, Stamford, CT, 06903, US

(21) Appl. No.: 12/354,771

(22) Filed: Jan. 15, 2009

Related U.S. Application Data
(60) Provisional application No. 61/021,398, filed on Jan. 16, 2008.

(51) Int. Cl. G09B 5/00

(52) U.S. Cl. 434/350

(57) ABSTRACT

The present invention relates generally to computer programs and other systems and methods that provide methods for some or all of the following: developing, administering and grading tests, assignments and other evaluations, and analyzing, compiling and reporting the results. One simple embodiment of the present invention provides methods for educational instructors to develop tests for their students, to grade those tests, to analyze those grades and to produce reports of those grades and that analysis.

### CROSS REFERENCE TO RELATED APPLICATIONS

This patent application claims the authority and filing priority of U.S. Provisional Application 61/021,398, filed on Jan. 16, 2008, which is incorporated by reference herein; EFS ID: 2723885

### FEDERALLY SPONSORED RESEARCH

None

### SEQUENCE LISTING

None

### A] PATENTS AND PATENT APPLICATIONS REFERENCED.

United States Patent Application 20030031996.

U.S. Pat. No. 7,088,949

U.S. Pat. No. 6,181,909

U.S. Pat. No. 4,839,853

United States Patent 20060100852

### B] SUMMARY

1) Short Description of the Present Invention; Developing, Grading and Reporting

The present invention comprises a grading system with some or all of the following features:
[1] users, including evaluators such as individual teachers, instructors, professors, teaching assistants, graders, test administrators, or one or more academic departments, faculties, schools, universities, text book writers or publishers, or any and all other persons acting as evaluators,
[2] responders, including students, candidates, applicants or other individuals or group or groups of individuals, to respond to instructions,
[3] instructions, including evaluations, tests, exams, quizzes and/or assignments, to evaluate, including to test, assess, examine, quiz, estimate, review, refresh, stimulate, challenge or renew, those responders' capacities, including their knowledge, learning, experience, understanding, abilities, skills, performance, resources and/or capabilities,
[4] methods for developing, including creating, reviewing, revising, modifying, extracting from, adding to, extending and/or enhancing, such instructions,
[5] methods to provide, including give, transfer, transmit, distribute, upload, download, email, reference, provide access to or make available, instructions to one or more responders,
[6] methods to obtain, including receive, transfer, transmit, distribute, upload, download, and/or obtain access to, responders' responses to such instructions, including any answers to questions and/or completion of other tasks the instructions may include,
[7] a grading procedure to grade, including score, mark, assess or otherwise evaluate, the responders' responses to such instructions, including by providing one or more numerical grades to such responses, to portions of such responses, to responses to particular instructions, or otherwise, in aggregate or separately,
8] analysis methods for analyzing the results of such grading, including the grades,
9] reporting methods for reporting the results of such grading or other evaluation, including the grades, and/or reporting such analysis, including some or all of the following: analyzing, assessing, compiling, storing, retrieving, publishing, reviewing, transferring, transmitting, distributing, formatting, extracting, monitoring, tracking, organizing, comparing, combining, displaying, compressing, recording, revising, and/or processing such results and/or such analysis, and/or
10] compilation methods for compiling, comparing or contrasting such reports or such analyses with one or more other reports or analyses, or with other materials or data, including other reports, analyses, materials or data in respect of one or more of the following: responders, users, including instructors or other evaluators, and institutions or institutional subdivisions, including academic departments.

For purposes of this document, a person includes an individual, a group, division, company, entity, legal person (including a trust, partnership or corporation), department, faculty, school, university, college and/or other institution of learning, or other institution, government body, government agency and/or government authority, and private or public board or other organization of admission, approval, authorization, certification, examination, licensing, permission, qualification or testing.

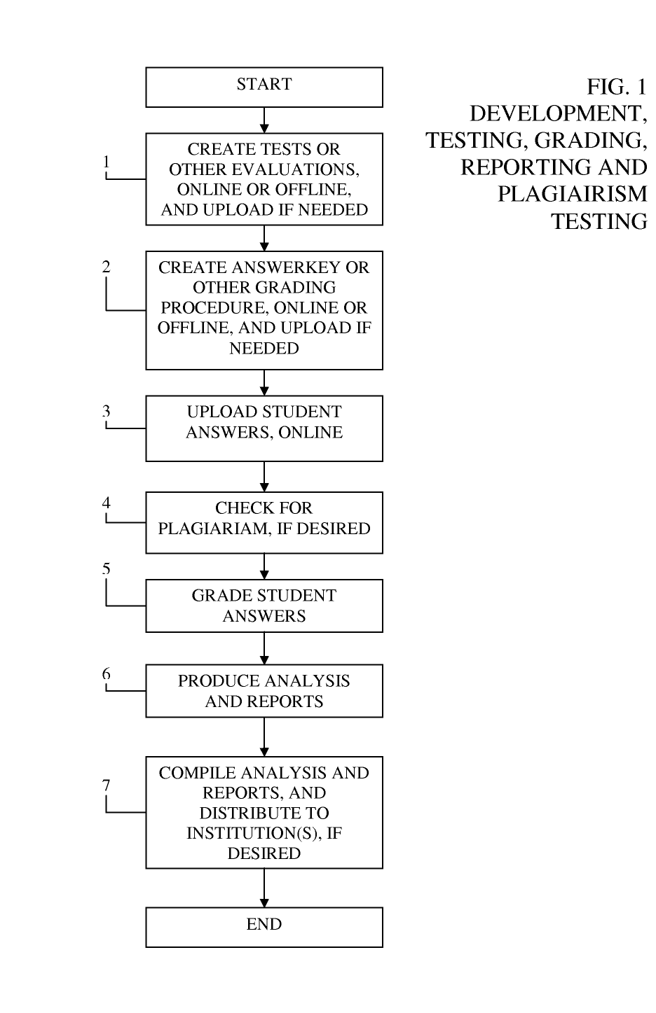

FIG. 1 in the attached Drawings describes a broad overview of certain embodiments of this system. In these embodiments, numbered paragraph 4 above is shown as 1 in FIG. 1, paragraph 6 is shown as 3 in FIG. 1, paragraph 7 is shown as 2 and 5 in FIG. 1, paragraph 8 above is shown as 4 and 6 in FIG. 1, and paragraphs 9 and 10 above are shown as 6 and 7 in FIG. 1.

2) Concepts and Synonymy

Among other procedures, the grading procedure of the present invention includes (sub)procedures to address synonymy and polysemy, which, as described below, are two fundamental problems confronting any grading procedure that is based on textual analysis. The grading procedure incorporates these procedures, as described in D]3) below.

Synonymy refers to the problem that different words and phrases can mean the same thing, and an appropriate reference to any of several synonymous and equally correct words or phrases must receive grading credit, without duplication—a reference to two synonyms should receive credit only once, not separate credit for each.

The problem of polysemy is that a single word or phrase may have different meanings in different contexts. For purposes of this document, polysemy includes homonymy, arising when several words share the same spelling but have different meanings.

As described in greater detail in D]3)iii) below, certain embodiments of the current invention includes methods for the user to develop and specify grading procedures that include procedures for addressing both synonymy and polysemy. These embodiments include grading procedures based on concepts. In these embodiments, a concept comprises specification of a structure of terms, or a terms structure, including one or more terms, such as words or phrases, to occur singly or a specified number of times, alone, together with or excluding other terms. The specification of occurrence with, or excluding, other terms may include proximity limits, such as requiring that the other terms occur (or not occur) within the same sentence, or paragraph, or within a specified number of characters, words, sentences, or paragraphs.

Once the user has provided the term structure for one or more concepts, these embodiments provide as part of their grading procedure a procedure to search or otherwise analyze a response's text, and possibly other response properties, including word location, order and formatting, to see the extent to which the response is consistent with, or, in certain of the embodiments, matches, the specified terms structure(s). In the embodiments that provide matching methods (“Matching Embodiments”), the extent of matching between response and concept is treated as the extent to which the response appropriately references the concept and the associated terms.

In several embodiments, therefore, a response is graded based on the extent to which that response is consistent with the concepts the user has specified. In certain of these embodiments, namely in the Matching Embodiments, consistency is determined based on the extent to which the response references each concept appropriately, based on matching. Examples of Matching Embodiments and other embodiments are described in D]3) below.

To address synonymy, these embodiments provide the user methods to include, in a concept's terms structure, synonym groups, including groups of terms that are to be treated as synonymous, a reference to any one of which will be treated as a reference to the (same) concept. A synonym group thus represents the concept for which the terms in that group are synonyms. Certain of these embodiments provide the user with methods to specify weights for one or both of the following: (a) weights for concepts or synonym groups, reflecting the relative importance of the different concepts, (b) weights for individual synonymous terms, reflecting how closely associated with the corresponding concept the user specifies those terms to be.

To address polysemy, these embodiments provide the user the ability to include in a concept's terms structure contextual requirements for terms to be treated as referenced in a response, and thus contextual requirements for receiving credit under the grading procedure for such references. By requiring a reference to a term to establish an appropriate context that justifies treating that reference as a reference to the associated concept, these embodiments provide a procedure to reduce the risk that an accidental or otherwise spurious reference to a term will be treated as a reference to that concept, thus reducing the risk of polysemy. This method for reducing the risk of polysemy is illustrated below.

In certain embodiments, these specifications are expressed in the form of “Regular Expressions”, a comprehensive syntax for matching strings that is well known in the art. See, for example, Friedl, J. Mastering Regular Expressions (O'Reilly Aug. 8, 2006.) Regular expressions permit efficient computer- based determination of the extent of a match between a pattern of terms, such as that specified in a terms structure, and a string, such as the text of a response. Certain concepts, comprising terms structure patterns, are matched if the associated terms occur in the alternative, in that the pattern is found if any one of alternative terms in the terms structure are found. For example, the terms structure consisting of “French Revolution”, “Storming of the Bastille”, and “Reign of Terror” in the alternative, might represent a term structure, comprising alternative synonyms, for a reference to the concept of the French Revolution of 1789. Regular Expressions may accommodate more complex terms structures, for example, a Regular Expression may test for the following pattern: “Storm” or “Storming” within four words of “Bastille”. Other concepts, also comprising terms structure patterns, are matched if the associated terms occur in the conjunctive, in that the pattern is found only if the associated terms are all present. For example, a user might specify that a reference the “Bastille” constitutes a reference to the concept “French Revolution” only if there is a reference to “1789” within the same sentence, or same paragraph. Such a conjunction increases the likelihood that the substance of the response addresses the French Revolution and not, for example, a stop on the Paris Metro, thus reducing the risk of polysemy.

More complex terms structures for concepts could require that certain terms be matched in the alternative, while other terms be matched in the conjunctive, or in the negative (i.e. not occurring), or matched in the alternative, conjunctive or negative with specified proximity to yet other terms.

The terms structures described above may all be expressed easily through Regular Expressions. Expressing certain other terms structures through Regular Expressions may be difficult or impossible. For example, a concept the terms structure for which requires that the term “Reign of Terror” occur at least twice as frequently as the term “Robespierre” is challenging to express in a Regular Expression. Another embodiment of the present invention, however, provides methods to express such terms structures by going back to first principles: parsing a response to process sequentially all the words it contains in order, and thereby determining whether the pattern in a particular terms structure can be matched. These methods are flexible enough to accept any terms structure that may be written down as a decision tree, or otherwise as an algorithm expressed in a finite numbers of statements, and to permit determination of the grade based on that terms structure in a flexible, if potentially complex, manner, such as a grade that increases the higher the number of terms associated with a concept that are matched, subject to a maximum grade, or alternatively a grade that tapers off based on a logistic or other function with an asymptotic limit.

By way of more specific illustration, one simple embodiment of the present invention, described in greater detail in F]2) below, provides methods to test for matches with terms structures that are based on:
1) Boolean connectors among terms (“and”, “or” and “not”) and
2) A method for matching terms, subject to these connectors, with either
   a. any substring of a response's text (“Includes”),
   b. the entire text of the response (“Exact Match”), subject to deletions the user specifies should be made before matching of terms, or
   c. every substring of a response's text (“Exact List”), subject to prior deletions as above, so that the union of the matched substrings comprise the entire response text, after the deletions.

The prior deletions referred to above include both (x) stoplist filtering, comprising deletion of certain extremely common words, like “the” and “a”, contained in a stoplist of terms that the embodiment provides the user a procedure to edit, and (y) deletion of one or more characters or classes of characters, such as some or all punctuation, some or all numerals or some or all letters. The embodiment provides the user procedures to specify these items, deletion of which from the responses text does not detract from the conclusion that the response correctly referenced the relevant concept(s) appropriately. Indeed, in the case of Exact Match and Exact List, the deletions may be needed to meet the requirement that the entire response text be matched, in case, for example, the instructions comprise a multiple choice question (the answer to which a responder must select from a list of specified choices) and the response text includes the correct choice, but adds parentheses.

The first matching method in 2)a above is appropriate for responses to instructions such as essay questions that contain more text than the terms specified to reflect the concept or concepts of the grading procedure. In this event, the additional text should not detract from the conclusion that the Reponses correctly referenced the concept or concepts specified by the user, and thus the grading procedure should ignore the additional text by matching only substrings. Alternatively, the grading procedure may grade the additional text based on measures in addition to or in lieu of matching terms, such as length, correctness of grammar, syntax and usage, and quality of writing. The additional text should not, however, be treated as detracting from the conclusion that the response appropriately referenced the specified concept(s), based on correctly matched substrings.

The second and third matching methods in 2)b and 2)c above are appropriate for responses to instructions such as to multiple choice or true/false questions (the answer to which is either true or false), where the grading procedure checks for one or more exact match(es) between one or more terms and the entirety of the response text. In 2)b above, the response text, after stoplist filtering and any deletions, should match exactly the term structure. Additional text suggests that the specified concept or concepts were not correctly referenced. In 2)c above, the response text, again after filtering and deletions, should match exactly a disjoint union of terms in the term structure.

In each of 2)a, 2)b and 2)c above, there may also be a separate term structure that should not be referenced in response. For example, an evaluator may reduce the grade of a response that references incorrect or irrelevant concepts.

### C] BACKGROUND OF THE INVENTION

1) Computers and Education; Current Environment

Computers have been a growing part of student education since John George Kemeny and Thomas Eugene Kurtz first developed the BASIC language in 1963. Although originally used in science and engineering, computer use by students broadly throughout their learning, in liberal arts and otherwise, began with the release of the IBM personal computer in 1981. The IBM personal computer began the transformation of personal computing from a specialty market directed towards technology enthusiasts, toward the near-universal use we see at present. By the end of the 1983, IBM had sold approximately 750,000 units, viewed as a wild success.¹ By 2004, almost 180 million IBM PC “clones” were sold annually.² Many schools currently have a policy requiring or urging students to own a PC. See, e.g, http://www.policy.ilstu.edu/technology/9-6.shtml (University of Illinois); http://www.sco.gatech.edu/downloads/sco2007.pdf (Georgia tech.) Currently, close to 100% of US college students own or otherwise have access to a person computer. See, e.g., http://www.studentmonitor.com/press/09.pdf; http://www.stolaf.edu/services/iit/newsletter/02-07/survey0607.html ¹http://lowendmac.com/orchard/06/0811.html²http://arstechnica.com/articles/culture/total-share.ars/9

The growth in personal computer ownership has been driven in significant part by the growth in the internet. Improvements in internet authentication and other security, notably the release and improvement of the Secure Sockets Layer (SSL) and its successor, Transport Layer Security (TLS), have permitted a broad array of services and transactions to be offered over the Internet. In addition to banking and commercial transactions, these services also include education. Areas in which the Internet has facilitated education range from the lecture notes, exams, and other resources from more than 1700 courses spanning MIT's entire curriculum that are simply offered online at http://ocw.mit.edu/OcwWeb/web/home/home/index.htm., to entire curricula that are available entirely on-line, for example, at the University of Phoenix. Many pundits and key figures in the internet hardware and service industries have extremely high expectations for the future of on-line education. For example, John Chambers, chief executive of Cisco Systems Inc, has described eLearning as potentially exceeding e-mail in its size. Current estimates for the market size of internet-based learning significantly exceed $10 billion. The prevalence of personal computers, and computer-based networks and platforms, in the current educational environment offers great potential to use computers to free instructors and other evaluators from the more repetitive, tedious and less interesting, although critical components, of teaching: Developing evaluations, administering the evaluations, Grading the evaluations, and Reporting the grades. However, the emphasis on on-line education largely has ignored the computer's potential to automate these functions in a practical and useful manner.

Instead, the principal direction and emphasis of commercial invention focus has been on electronic learning platforms, such as Moodle (a free software e-learning platform, also known as a Course Management System (CMS)) and Blackboard Inc. The principal direction and emphasis of academic invention has been on the application of established machine learning techniques to essay grading. As discussed in greater detail below, neither of these directions adequately addresses the needs of most evaluators, for example, custom users, including users comprising one or a small group of users, such as educational instructors, that need to construct a specific, customized homework assignment or test for a conventional class of students on specialized substantive topics covered as part of a conventional educational course.

2) Prior Art.

As indicated above, prior art discloses two broad categories of grading invention. The first category comprises a subset of broad, commercially-distributed educational platforms that may provide, among many other services, methods for grading multiple choice questions, and very limited, and rarely used, essay grading. This category of commercially-available electronic grading also contains methods offered by certain textbook publishers for electronic grading of pre-specified questions, with no method for users to develop their own questions.

The second category comprises the academic investigation of the application to essay grading of established machine learning techniques based on extensive training on previously-completed essays graded by humans.

No invention in either of these categories offers the flexibility and customizability of the development methods or grading procedures included in the present invention, particularly for custom users.

i) Educational Platforms

Several on-line (network-based) electronic education platforms (“OEPs”) have been commercially available for a number of years. Two of the principal educational platforms currently available are Moodle, which is free and open source, and Blackboard/WebCT, which is proprietary, commercial and expensive. According to Wikipedia, Moodle has a significant user base with 25,281 registered sites and 10,405,167 users in 1,023,914 courses (as of May 13, 2007). In 2006, Blackboard merged with WebCT, another CMS. The resulting entity is substantially larger than Moodle and had consolidated revenues in excess of $180 million in 2006. Blackboard is currently the dominant OEP provider.

ii) Education Platform Patents

Blackboard has received a patent, U.S. Pat. No. 6,988,138 titled “Internet-Based Education Support System and Methods” (the “Blackboard Patent.”) The Blackboard Patent provides a useful window on the commercial on-line electronic education platforms (“OEPs”) generally. The Abstract of this patent describes it as “[a] system and methods for implementing education online by providing institutions with the means for allowing the creation of courses to be taken by students online . . .” The Description of the Preferred Embodiment in the Blackboard Patent states
. . . the present invention comprises a system and methods for the exchange of course content and related information between non-collocated instructor users and student users. An instructor user interacts with one or more non-collocated student users by using the system and methods of the present invention to, without limitation, transmit course files including course lectures, textbooks, literature, and other course materials, receive student questions and input, and conduct participatory class discussions using an electronic network such as the Internet or World Wide Web. Access to the course file is controlled by access levels and control logic, to ensure integrity and security of the system. Also, administrator users have access to the system to perform administrative tasks as defined herein.

Blackboard's system and methods described in that patent address online education exclusively. Those systems and methods provide for instructor interaction “with one or more non-collocated students by transmitting course lectures, textbooks, literature, and other course materials, receiving student questions and input, and conducting participatory class discussions using an electronic network such as the Internet and World Wide Web.” (Emphasis added.) This emphasis on online education is typical of all OEPs.

iii) Historic Computer-Based Testing and Grading

Computers have for some time been used to grade, and more recently, to administer, certain types of examinations, principally those the questions in which are similar to multiple choice. The answers to these questions must be electronically selected by the responder from a specified finite list, through mouse-clicks or otherwise (“check-the-box” questions.)

The process of grading check-the-box questions electronically extends back many decades. See, e.g., page 134, Greene, E. B., The Measurement of Human Behavior, New York, The Odyssey Press (1941) (referring to the IBM Scorer from 1938.) Electronic grading of check-the-box questions may be viewed conceptually as the electronic embodiment of a classic “answer sheet” form that a responder is instructed to complete, with boxes and ovals to check or fill-in to indicate the responder's choices. Computers have automated the task of grading check-the-box questions, replacing the prior practice in which humans used grading “grids” or “masks” to cover the answer sheets forms on which the responders were required to provide their responses. These grids revealed only the correct answers, allowing the responses to the questions to be graded by simply checking whether the only answer revealed by the superimposed grid was checked by the responder. The grids were more efficient than grading by visually inspecting each answer given by a responder to determine whether it was correct, and computers are still more efficient. Computer grading is also more accurate than the grids it replaces, since human graders eventually tire of performing tedious, repetitious tasks, after which the frequency of errors by those human graders rises.

Because of the increased efficiency and accuracy of computer grading of check-the-box questions, such computer grading has practically replaced human graders in most large-scale testing administered to large groups of students or other applicants. In the latter half of the twentieth century, for example, the check-the-box questions in standard certification exams began to be graded by computer, including the widely administered tests used in the school application process, such as the SAT and the PSAT, as well as the state bar exams routinely given to aspiring lawyers,. More recently, certification exams, such as those administered by the National Association of Securities Dealers (now called “FINRA”), are administered and quickly graded by computers, in secure testing facilities in which responders are presented with their grades on the tests they have taken within minutes of finishing those tests. These examples of computer grading are not isolated, the preponderance of the questions in the large-scale tests and exams described above are check-the-box questions, and these are now almost invariably graded by computer. Not only is computer grading of check-the-box questions efficient and accurate, but the underlying technology is easy and readily available. For example, the ubiquitous Internet-based catalogs and order forms for ordering goods and services, wherein a customer must select items by checking various boxes or clicking various buttons, provide substantially similar technology.

As indicated above, the dominance of computer grading of check-the-box questions is attributable to its efficiency, accuracy and availability. These advantages provide a variety of benefits. Because of the efficiency of computer grading, and particularly the speed, in many cases, the test takers may receive their grades, including detailed analysis of individual questions and other feedback, within minutes of completing the test. Other advantages included greater flexibility; the earlier pre-printed grids could not quickly be changed, while, in the current age of pervasive computer networking, computer-administered grading may easily be revised up until the moment the test is given, permitting easy randomization of questions and thereby discouraging plagiarism, among other benefits. As a result of the many advantages of computer grading, several testing companies (for example, Prometric, a company recently sold by The Thomson Corporation to Education Testing Services for $435 million) have grown into very substantial business.

The price of these advantages of computer grading has been rigidity. As stated previously, computer grading has traditionally been confined to check-the-box questions, the responses to which are confined to an enumerated list, a data structure easily analyzed by computers. Unfortunately, check-the-box questions, however carefully constructed, do not easily permit testing on multiple concepts and the relationships between those concepts. Also lacking is the ability to generate questions quickly and efficiently from materials readily available to individual instructors and other evaluation developers and evaluators. The growth of computers in test grading has thus resulted in concentration of test development, administration and grading, and related products and services, in specialized outside vendors with long set-up times, high costs and typically institution-to-institution relationships. Individual instructors and other small groups of developers and evaluators have until traditionally been ignored.

Recently, several companies have begun to offer products intended to provide the advantages of computer grading to individual developers and evaluators that are part of large institutions, like universities. As discussed further below, the methods of these products develop evaluations almost entirely on-line, and grade entirely on-line, as an integrated part of OEPs, and emphasize check-the-box questions.

iv) Commercial Grading in Education Platforms.

The prior art for automatic electronic grading in education platform is limited. Certain OEPs offer limited grading, typically for check-the-box questions. For example, the Blackboard Patent includes “[t]ests provided to students [that] may be password protected and timed, and may provide instant feedback to students.” The Blackboard Patent refers to “quiz[zes] that may be taken online, wherein the answers may be graded automatically, in real-time, as soon as the student has finished the quiz. This assessment functionality will be explained in greater detail below.” Despite the reference to “graded . . . automatically”, the Blackboard Patent disclosed no method for “automatic grading”, other than referring to it from time to time, for example, stating that “instant feedback is provided through automatic grading functionality.” One is left to infer that “automatic grading” refers to prior art, and not to the invention in the Blackboard Patent. Blackboard does provide integration with Respondus, Inc., a company that develops testing, survey, and game applications for electronic education platforms. These applications do not include methods for instructor development of assignments, tests and exams outside of the specified host on-line platform, and particularly absent is any significant method for developing, testing, grading or reporting (some or all of which, “DTGR”) with respect to essay questions or other questions more complex than “check-the-box” ones, inside or outside of the specified education platforms. Thus, the direction taken by electronic grading in OEPs has been to develop and improve the overall educational on-line platform, including as part of that effort automatic grading of certain questions, principally, although not entirely limited to, on-line check-the-box questions. As a result of the emphasis on the overall educational on-line platform, development and grading in particular have not historically received extensive independent attention in the context of OEPs.

As a result, the grading procedures currently offered as part of the commercial OEPs are ill-suited for many users, such as custom users, that need to construct a specific, customized homework assignment or test for a conventional class of students on specialized substantive topics covered as part of a conventional educational course. OEPs provide little in the way of development, testing, grading or reporting methods to evaluators outside of the specified on-line education platforms. With respect to questions other than “check-the-box” questions, such as essay questions, OEPs offer an evaluator little or no methods for electronic grading. Evaluators must generally grade such questions themselves. As discussed below, what grading OEPs do offer is severely limited.

In particular, using an OEP, a user may generally create a test or assignment only on-line. OEPs currently provide neither methods to create an evaluation off-line and upload it to the OEP, nor, once the evaluation has been created, methods to receive responder responses off-line and upload them to the OEP. Methods provided by OEPs to grade essay questions are too rudimentary to be useful. No methods are provided to grade misspelled answers and nor do OEPs provide any methods for users to reflect in grading the extent of any misspelling by responders, whether by subtracting an appropriate number of points for the misspellings or otherwise. Finally, OEPs provide no methods to compare the answers to essay questions of different responders and test rigorously for potential plagiarism

v) Commercial Grading Outside of Education Platforms.

Prior art shows a certain amount of grading procedures outside of OEPs. Certain textbook companies provide on-line grading services for check-the-box questions, typically ones chosen from the textbooks they publish. A few of these grading services also provide on-line essay grading for a fixed set of pre-specified questions, using some of the techniques described below based on extensive “training”, discussed in greater detail in C]2)vi) and C]2)vi)[2] below. For example, the publisher, Holt, Rinehart and Winston offers such on-line essay scoring. None of these on-line grading services provide methods for custom users to develop, grade or report, on-line or otherwise, their own questions, particularly not if those questions are essay questions. No method is provided for users to reflect in grading the extent of any misspelling by responders, or to compare the answers to essay questions of different responders and test rigorously for potential plagiarism.

Prior art also provides limited essay grading in the context of a preparation service for essay questions that are part of certain standardized tests. A 2001 patent application describes “A computer-assisted method of evaluating an essay, comprising: receiving an essay concerning an essay topic; electronically comparing textual content of the essay with a first number of terms related to said essay topic; identifying missed terms, the missed terms being those terms which are among said first number of terms, but are not present in the textual content of the essay; and transmitting the missed terms.” United States Patent Application 20030031996. An embodiment of this invention is the “RocketScore™ Essay grader”, available at http://www.rocketreview.com/rocketscore_demo.php.

According to the patent application, this invention is based on a set essay or group of set essays and a “number” of terms that should be in a “model essay”, or an “ideal, model essay”, on the essay topic. A “number of terms” should be “extract[ed]” from the terms found in the model essay. A second, submitted essay is then searched to see which of the “number of terms” are missing and which are present. A “score” for the submitted essay may be transmitted, presumably based at least in part on the extracted terms that are present and those that are missing. Some weighting of the different terms appears to be contemplated. This invention appears to address primarily a SAT test preparation service for users who are responders. The invention provides no method for users who are developers or evaluators to develop evaluations or methodology upon which to grade evaluations. The number of terms described in the patent application, without logical rules based on which to apply them, tests only for the appearance or absence of the precise enumerated terms, and as such does not address synonymy or polysemy.

By contrast, as described in greater detail in B]2) above and elsewhere herein, the preferred embodiments of the present invention provide sophisticated grading functionality that can determine whether any of an arbitrary number of synonymous terms are present, providing equal, non-cumulative credit for each, thus addressing synonymy. By requiring the appearance of multiple terms to receive credit for any one of those terms, the preferred embodiments of the present invention also addresses polysemy.

vi) Prior Art of Automatic Essay Grading.

[1] Academic Development of Essay Grading.

There has been some progress in designing computer programs that can grade essay questions, and that progress has given rise to some art. For example, U.S. Pat. No. 7,088,949 describes one such essay-grader. U.S. Pat. No. 6,181,909 describes another. The essay grading offered, however, is in all cases too rigid to be useful to custom users, suffering from, in a very different form, similar rigidity to that associated with automatic grading of “check-the-box” questions.

The development of essay grading has generally been derivative of computer science developments from the past several decades. The prior art of essay grading applies established machine-learning techniques, such as that developed in text classification, described to below, to essay grading. For each essay topic, the associated grading methodology requires extensive statistical analysis of hundreds or thousands of essays on that topic that have been previously graded by humans, and in some case also requires additional review by an essay grading expert. The methods described in the two patents mentioned above each require training on hundreds or thousands of essays on the same topic that have been previously graded. U.S. Pat. No. 7,088,949 states that the grading is to be accomplished by “trained judges”. The essay graders described in both patents are based on retrieval methods dating back to 1979 and earlier. See, e.g., C. J. van Rijsbergen, Information Retrieval (London: Butterworths, 1979), available on-line at http://www.dcs.gla.ac.uk/Keith/Preface.html. In such methods, documents are represented by term vectors, and relevance to a particular search queries, also represented as a term vector, is determined by a geometric or other measure (such as the cosine of the angle between the two vectors.) See generally, Rijsbergen, chapters 3, 5. These methods have been enhanced through, for example, application of mathematical decomposition techniques, such as the “singular value decomposition” to determine the “latent semantic structure” of groups of documents and queries. See, e.g., Deerwester et al, U.S. Pat. No. 4,839,853 (filed Sep. 15, 1988); Deerwester et al, Indexing by Latent Semantic Analysis (Journal of the American Society of Information Science 1990), Dumais, S. et al, Using Latent Semantic Analysis To Improve Access To Textual Information (Bell Communications Research 1988). These techniques typically require extensive datasets for training and produce complex decision rules. See, e.g., the rules used by an essay grader referred to in Appendix B2 of U.S. Pat. No. 6,181,909.

One area of machine learning that does not require extensive training and yields compact results is based on information theory and entropy, described in detail in an important 1986 paper by J. R. Quinlan. Quinlan, J. R., Induction of Decision Trees, (Machine Learning 1: 81-106, 1986) (hereinafter, “Quinlan”.) One stated purposes of the method (“ID3”) described in that paper and subsequent improvements (such as C.45) is to produce simple decision rules by preferring “attributes” that offer the highest “information gain” and can produce “reasonably good decision tree is required without much computation . . . generally . . . construct[ing] simple decision trees . . . ” Id. at 88.

“Information gain” refers to the measure of information developed by Clause Shannon and extended by Solomon Kullback. These information measures have been applied to human language text by Shannon and more recently applied to certain aspects of text retrieval, such as term weighting. See, e.g., Shannon, C. E. (1948), A Mathematical Theory of Communication, Bell System Technical Journal, 27, pp. 379-423 & 623-656, July & October, 1948 (hereinafter the “Shannon Information Paper”); Shannon, C. E., Prediction And Entropy Of Printed English, Bell Systems Technical Journal, 30, 50-64 (1951); Kullback, S., and Leibler, R. A., 1951, On Information And Sufficiency, Annals of Mathematical Statistics 22: 79-86, Dumais, S., Improving The Retrieval Of Information From External Sources, Behavior Research Methods, Instruments, & Computers (1991, 23 (2), 229-236.) One embodiment of the present invention provides methods to assist users in evaluation development based on information gain, as described in greater detail in D]6)i)[2] below.

[2] Background: Brief History of Machine-Learning, Writing Evaluation and Essay Grading.

In 1948, Clause Shannon published the Shannon Information Paper, which became the seminal article on measurement of communication and the basis for “information theory.” In this paper, Shannon defined a mathematical measure of information, extending the work previously done by the celebrated German physicist Ludwig Boltzmann, who defined entropy in 1870. Mathematically, Shannon's information is opposite of Boltzmann's entropy. A system or other structure has information to the extent it lacks entropy, and conversely. As stated above, in 1950, Shannon applied his methodology to analyze human language. The 1950s were a good decade for computer science in general and machine learning in particular. In 1952, Arthur Samuel wrote a checkers player. This checkers player incorporated a “genetic algorithm.” In 1957, Frank Rosenblatt built the “perceptron” at the Cornell Aeronautical Laboratory, the first neural network, a linear classifier. The perceptron became the basis for both “neural networks” and “Support Vector Machines.” Neural networks are generally used for classification, and, by extension, pattern recognition. Neural networks are based on coupling one or more (possible large) groups (or “layers”) of threshold functions, which are generally binary, returning either 0 or 1, or nearly binary, such as a sigmoid function. Support Vector Machines are also used for classification and pattern recognition, and are based on linear programming methods used to construct a function that separates objects into different classes and does so “optimally” in a specified sense. Neural Networks and Support Vector Machines are both part of prior art and are discussed in many textbooks and journal articles. Support Vector Machines in particular are comprehensively described in Shawe-Taylor, J. & Cristianini, N., Support Vector Machines And Other Kernel-Based Learning Methods, (Cambridge University Press, 2000.)

Both neural networks and support vector machines have been proposed as methods to assess the quality of written English skills. See, e.g., Schwarm, S. & Ostendorf, M., Reading Level Assessment Using Support Vector Machines and Statistical Language Models, Proceedings of the 43rd Annual Meeting of the ACL, pages 523-530, Ann Arbor (June 2005); United States Patent 20060100852, Technique For Document Editorial Quality Assessment.

The common underlying feature of neural networks, support vector machines and most other machine learning methods is a statistical method that requires training on many examples previously processed by humans. These methods are frequently similar to the classical mathematical technique of “least squares regression” and related “curve-fitting” techniques that rely on past data with known values to construct a function that can be expected to produce correct values for new data. Genetic algorithms, in turn, require many trials to permit the “strongest” to survive.

Because these machine learning methods are based on large statistical samples, they require extensive preparation, including analysis of hundreds or (better) thousands of examples. These methods may be satisfactory to a large institution engaged in providing large numbers of questions on the same topics to large numbers of responders over many years. Such institutions would place high value on the efficiency and objectivity offered by machine-based grading of those questions and would also have the time, resources and scale required for the training and other preparation.

These machine learning methods requiring extensive prior data are, however, ill-suited for many other users, particularly custom users. The extensive training required by the machine learning methods may benefit such users indirectly, by helping establish large groups, or “banks”, of questions that can be made available to large groups of such users, perhaps in conjunction with the course textbooks for the associated courses, as discussed in C]2)v) above. However, these methods are substantially useless to users that need to develop their own questions to construct specific, customized homework assignments or tests for conventional classes of students on specialized substantive topics covered as part of conventional educational courses. For such custom users, collecting the extensive data needed to apply large-sample statistical methods, requiring training on hundreds or thousands of previously-graded answers to the same or similar questions, is at minimum difficult and typically impossible. Not only is such extensive data essential to conventional machine learning methods, but the data must moreover be in a form readily amenable to machine-based statistical analysis. In addition, these machine learning methods are rarely incremental, requiring instead a complete and comprehensive analysis of all available data, old as well as new, whenever new data becomes available.

Accordingly, existing machine learning methods are of at best limited use to custom users and other evaluators who do not have easy access to and extensive familiarity with large-scale computer-based statistical applications.

Because of their reliance on large-scale statistical methods that are not incremental, existing machine learning methods are neither dynamic nor flexible. Accordingly, many of these methods address primarily the quality of writing and style in an essay answer, rather than the substantive knowledge the answer displays. Although undeniably important, writing and style quality, including grammar, syntax and usage, inherently depend on sufficiently many factors that large-scale statistical methods are vital to any effective machine-based evaluation of them. Writing quality and style also vary tremendously by period, geographic area and discipline. A review of, for example, Edward Gibbon's The History of the Decline and Fall of the Roman Empire will indicate how dramatically the standard for good writing and style has changed since the late 18^{th} century.

The large-scale statistical methods used by existing machine-learning methods require analysis of hundreds or thousands of graded answers with thousands or hundreds of thousands of different features. In part as a result, existing machine-learning-based essay grading procedures develop complex grading methodologies, the significance of which is often difficult for a human user to understand. A human user therefore has difficulty monitoring, reviewing, revising and controlling these methodologies, and must typically simple take them as a given. See, e.g., the rules used by an essay grader referred to in Appendix B2 of U.S. Pat. No. 6,181,909. This characteristic of existing essay grading methodologies contributes to their rigidity from a user's perspective.

In sum, existing essay grading procedures cannot offer custom users any methods to grade essay answers without extensive preparation and analysis of many previously-graded answers. Such essay grading procedures are accordingly of limited use in grading essay answers on new topics, or indeed in grading essay answers on any topic for which extensive data on the grades provided to past responses on that same topic are unavailable to the user. Existing essay grading procedures inherently incorporate measures, such as writing style, that do not directly address the substantive knowledge referenced in responses. Measures of essay quality like writing style vary heavily based on context, and machine-based methods to evaluate these measures are difficult or impossible for a custom user to monitor, revise or control. As a result, from a user's perspective, existing essay grading procedures are inherently rigid, in addition to being impractical to apply to new topics.

### D. DETAILED DESCRIPTION OF THE PREFERRED EMBODIMENTS OF THE PRESENT INVENTION

1) Design; Certain of the Improvements Over Prior Art.

The present invention, by contrast with prior art, addresses the needs of custom users, among other user groups. Specifically, in the preferred embodiments, users specify or accept the methodology that determines the grading procedure, although the system provides optional methods for proposing to the user promising grading methodologies obtained based on materials the user provides to the system, as described in greater detail below.

The design of the present invention addresses primarily substantive knowledge, in a manner intended to maximize flexibility. The present invention offers educational instructors, evaluators and other users methods to grade new essays and other questions and responses with modest, or no, statistical preparation or training, and includes methods to evaluate the substance of the responses. These methods are fully compatible with most, or all, methods to evaluate the quality of writing and style, which can be incorporated into the present invention or used independently.

In particular, several embodiments of the present invention provides to a user methods to develop, and revise flexibly and dynamically, a grading methodology that is based on grading attributes that include substantive criteria of response content and quality, as described in greater detail below. Certain embodiments provide to a user methods to analyze relevant materials provided by or on behalf of the user, and methods to identify automatically from that analysis promising grading attributes, also as described in greater detail below. Those embodiments provide users methods to review and edit the grading attributes that the embodiment provides. Other embodiments provide users methods to specify grading attributes in the first instance.

Based on the grading attributes, the user specifies a grading function. The grading attributes and the grading function together provide a grading procedure which may be applied to grade responses.

2) Environment, Platform and Transfer

i) Evaluators

Certain embodiments of the present invention provide to evaluators and other users flexible methods to develop evaluations and grading procedures, and provide to responders flexible methods to provide their responses to be graded.

More specifically, preferred embodiments provide evaluators and other users on-line methods to develop evaluations and associated grading procedures on-line, and off-line methods to develop them off-line. Off-line methods include methods to upload evaluations and/or grading procedures created off-line to the system, and methods to parse uploaded evaluations or grading procedures into a machine-readable, machine-usable form. Other embodiments provide either an on-line or an off-line method to develop evaluations and/or grading procedures, but not both. To create evaluations and grading procedures off-line in the preferred embodiments, a user should create an electronic document (i.e. a computer file) containing the evaluation or grading procedure in the easy, simple and flexible syntax that these embodiments provide, as described in greater detail below. (A specific example of the syntax is described in F]2)i) below.) The user may use any standard word processing program and format to create the file containing the evaluation or grading procedure, or may create the file in one of several alternative formats, including but not limited to “rich text file” (RTF) format (RTF is described in greater detail below.)

Having created an evaluation or grading procedure in a file off-line, in preferred embodiments a user may upload the file to the system using the upload method the embodiments provide. In these embodiments, the upload methods for evaluators include some or all of the following upload methods:
a) a standard upload procedure implemented in a browser,
b) a drag-and-drop upload procedure through a graphical interface in which the relevant file is dragged from its location on a graphical representation of the user's local machine to a graphical representation of the appropriate location on the embodiments' server, or
c) email of the file to a specified email address, from which these embodiments recover the file and process it.
d) Alternatively, other standard transfer methods known in prior art, including “file transfer protocol” or FTP, may be provided.

ii) Responders

The preferred embodiments and several other embodiments provide responders one or both of the following methods to provide their responses: on-line or off-line. The method for providing a response on-line includes a web address and security information, each of which is provided to responders. On entering that web address into a standard web browser, a responder is prompted to provide the security information. Upon entering the security information correctly, this method provides to responders a secure graphical environment in which to complete their response.

In preferred embodiments, the off-line method permits responders to provide their responses off-line, outside of the system, and then to upload their responses to the system. In these embodiments, a response provided off-line comprises a word processing, RTF or other computer file created by the responder off-line, on a local machine, local network, or otherwise, in any of the formats available to evaluators and other users, described above. The responder then transfers the file containing his or her response to the system or to the user through any appropriate methods, including email, FTP, “drag-and-drop” or other file transfer protocol, including any file transfer capability offered as part of an institutional OEP (whether purchased externally or developed internally by the institution.) Certain embodiments provide responders methods to upload their responses directly to the system of those embodiments, including without limitation some or all of the methods described in items a)-d) above for users.

3) Grading.

i) The Features Structure of a Response

As indicated above, the present invention includes grading procedures, among other components. To encode responses in a form to which the grading procedure may easily be applied, the preferred embodiments of the present invention includes a feature procedure to convert (i.e. map) each response into a features structure, which includes a computer readable data structure. By extracting and organizing, and frequently compressing, the information in a response, the response's features structure facilitates efficient and precise storage, retrieval, search and other processing of that information. Certain embodiments store and process the response in the form received from the responder, in effect setting the response features structure equal to the full response and sacrificing efficiency and precision for simplicity and completeness.

In other embodiments, the features structure may comprise any of the conventional data structures well-known in the art, such as vectors, lists or associative arrays (also known as dictionaries) or other arrays, or other data structures or objects.

For example, in certain embodiments, the features structure may be based on the text (including formatting) of the response. In certain of these embodiments, by way of example, the features structure of a response may consist of a features list, comprising the text of the response, viewed as an ordered list of the words in the response, possibly after stoplist filtering, with formatting and location information retained or discarded, as the user may specify. Thus, in one such embodiment, the features in a response features structure are simply the text of the words in the response, stripped of formatting and other non-textual information other than word order.

Alternatively, in other embodiments, the features structure may, in lieu of or in addition to a features list, consists of a features array, comprising an associative array containing one entry for each unique term in the response, after stoplist filtering, together with the number of occurrences, or frequency of occurrences, of that term. In these embodiments, the features array may lose information about the location, order and formatting of the terms taken from the response text.

In those embodiments in which the features structure is based on the response text, in addition to or in lieu of stoplist filtering, other filters may be applied to eliminate certain terms from the features structure. Such filters may include filters based on:
1) Similarity or dissimilarity with terms in materials provided by the user, as discussed in greater detail at detail in D]6)i) below, or
2) Similarity or dissimilarity with a general corpus of written English, such as the “Brown Corpus”, cited below on page 29.

Similarity or dissimilarity may be based on “mutual information” (also known as “information gain”), “chi-squared” measures or other statistical measures known in the art of text classification, discussed in greater detail in D]6)i) below.

In other embodiments, the features of a response's features structure are based on the occurrences in the response text of certain terms that the user specifies as comprising the term structure. In these embodiments, therefore, the grading attributes are based on the terms structure as well as the response text. The features structure in these embodiments may consist of any of the following
1) a list of the terms in the terms structure that occur at least once in the response text,
2) a features array indexed by the terms in the terms structure, with location, ordering and/or formatting information for each occurrence of each term, or
3) a features array indexed by the terms in the terms structure, with number of occurrences, or frequency of occurrence, of each term, stripped of location, ordering or formatting information.

Accordingly, a response features structure may, in various embodiments of the present invention, include some or all of the following:
1) The full response, including text, formatting and all other information in the response.
2) The full text of the response without formatting or other information.
3) Formatting, location and/or order information in respect of some or all of the response text.
4) Certain terms selected from the response text, such as
   a) terms selected by one or more filters, including a stoplist,
   b) terms that are contained in the terms structure specified by the user, and/or
   c) terms that otherwise meet certain requirements specified by the user, such as decision tree rules.
5) Some or all of the terms from the response text, stored as a list, associative array, and/or other data structure or computer science object.
6) Some or all of the terms from the response text with information indicating how many occurrences of those terms the response contained, or merely an indication that those terms occurred at least once.

In one simple embodiment, described in greater detail in F]2) below, the features structure of a response include the occurrences in the response text of certain terms that the user specifies as comprising the term structure. That terms structure comprises several synonym groups associated with certain concepts, as discussed in greater detail below. In this embodiment, the feature procedure converts a response to an enumeration of these occurrences, viewed conceptually as the number of the specified concepts that the response references appropriately, through including at least one of the terms in the associated synonym group.

ii) The Grading Procedure

[1] Comparing Features

In general, the grading procedure includes methods for comparing two features from two different response features structures to determine whether one feature is greater than, equal to or less than (i.e. deserves a better, the same or a worse grade than) the other feature, or (rarely) whether the two features cannot be compared. The grading procedure also includes methods to aggregate the results of comparing separate features in order to compare the overall features structures of two responses. If under the grading procedure one features structure is greater than a second features structure, the first features structure is provided a higher grade than the second features structure under the grading procedure. Although providing numerical grades is preferred, it is not required. In several embodiments, the grading procure ranks the responses without provide explicit numerical grades.

In certain embodiments, the grading procedure includes methods for converting (i.e. mapping) features and features structures to mathematical objects, such as real numbers, real number lists, real number vectors, real number arrays, integers, integer lists, integer vectors or integer arrays. In these embodiments, two features may be compared by comparing the mathematical objects into which the grading procedure converts them. These embodiments include methods for the user to specify the basis on which the grading procedure maps response features to such mathematical objects. In several embodiments, the mathematical object represents a measure of the consistency of the response features structure with the terms structure, as described below.

[2] Consistency Measures—Cosines

In certain embodiments, the grading procedure associates with a response features structure a single number, which number is intended to measure the overall consistency of the response features structure with the terms structure the user specified. In certain of these embodiments, the grading procedure determines this consistency measure by computing the cosine of the angle between the response features structure and the terms structure, after first converting each to a vector in a Euclidean space. Such a measure of consistency between a text and a specified query, viewing each as a vector, is well known in the art of information retrieval, as described in C]2)vi) above.

In one category of simple embodiments based on concepts and using this consistency measure, the dimension of the associated Euclidean space equals the number of concepts. Each concept is associated with an axis in the Euclidean space, and a response, through its features structure, is converted by the grading procedure to a point in that Euclidean space, as follows: each coordinate (along an axis) of the point into which the response is converted corresponds to the extent to which the features structure, and thus the response, appropriately references the concept associated with the axis corresponding to the coordinate.

In certain embodiments in this category, the coordinate of a response corresponding to a concept is either 0 or 1, depending on whether or not at least one term in the synonym group associated with the concept occurs in the response's features structure. In other embodiments in the category, that coordinate is zero or a positive integer, depending on the number of occurrences in the features structure of all the terms in that synonym group. In a third group of embodiments in this category, that coordinate is the total number of occurrences of all terms in that synonym group, divided by the total number of occurrences of all terms in all synonym groups. Certain embodiments provide the user with methods to specify weights for the occurrences of the terms in the features structure to be used in determining the point into which the grading procedure converts the features structure, either on the level of concepts or synonym groups in the aggregate, or on the level of individual terms, or both. If the term structure includes weights, these occurrence weights may or may not be based on any term structure weights.

By converting each features structure into a point in a Euclidean space, a grading procedure also converts each features structure into a vector, namely, the vector from the origin to that point.

The grading procedures in this category of embodiments also convert the terms structure to a point (and thus to a vector) in the (same) Euclidean space, with the coordinates corresponding to a concept determined based one some or all of the following: (a) the coordinate is “1” for each concept, (b) the coordinate is the weight for that concept (if the terms structure includes weights for concepts), or (c) the coordinate is a function of the weight for that concept (again, if there are terms structure weights).

Based on the principles underlying the mappings from features structures and terms structures to vectors just described, different embodiments of the present invention provide a user methods to specify many different mappings of features and terms structures to vectors. For example, in certain embodiments, if a term structure provides weights for concepts, the grading procedure converts the terms structure to a point, the coordinate of which corresponding to a concept is the related weight. This grading procedure converts a features structure to a point, the coordinate of which corresponding to a concept is the sum of the total number of occurrences of each term in the associated synonym group. The cosine of the angle between the two associated vectors (from the origin to the two points) then reflects the extent to which the occurrences of the concepts in the features structure reflects the terms structure weights.

Alternatively, in other embodiments, if a terms structure provides weights for individual terms, the grading procedure converts a features structure into a point, the coordinate of which corresponding to a concept is the weighted sum of the number of the occurrences of each term from the associated synonym group in the features structure, using as weights the inverse of the term weights from the term structure. This grading procedure converts the terms structure to a point, each coordinate of which is “1”. Again, the cosine of the angle between the two associated vectors reflects the extent to which the occurrences of the concepts in the features structure reflects the terms structure weights. The second grading procedure is, however, more computationally complex than the first grading procedure.

Features structures from different responses may then be compared by comparing the cosines of the vectors into which they may be converted with the vector into which the terms structure may be converted. The features structure with higher cosine is viewed as more consistent with the terms structure, and thus deserving of a higher grade.

[3] Consistency Measure—Concept List

In other embodiments, the grading procedure converts features structures into mathematical object that are concept lists, including numerical lists (or vectors), one entry in the list corresponding to each concept. In these embodiments, the concept list corresponding to a features structure has a numerical entry for each concept. This numerical entry measures the extent to which the response features structure appropriately references the concept.

In certain embodiments, the concept list entry corresponding to the extent to which response features structure refer to a particular concept appropriately is determined as follows. That concept list entry is the maximum of the point counts that the user specifies for the terms in the synonym group associated with that concept that occur in the response features structure, such as the text of the response. If no such term occurs in the response features structure, the list entry is 0. (These and other mechanics of the grading procedure are described in greater detail below.)

In such embodiments, features structures are compared based on their concept list entries. In more detail, for a particular concept, the associated feature of a first response is greater than, less than or the same as the corresponding feature of a second response if the entry in the concept list associated with that concept from the first feature is greater than, less than or the same as the corresponding entry in the concept list from the second feature. In these embodiments, features corresponding to a single concept may always be compared.

[4] Numerical Sum Grading

In one embodiment, the total grade for a response is then the numerical sum of the numerical entries in the concept list. This numerical sum may be viewed as a measure of the similarity between the response and the terms structure; if the numerical sum is large, the response and the terms structure are similar, and conversely. In the simplest case, in which the point count for each term in a synonym group is one point, the grade associated with a response is the count (i.e. total number) of those synonym groups having at least one term that occurs in the response structure. The numerical sum is largest when all synonym groups are referenced appropriately in the response features structure.

Even such simple embodiments can provide users flexible methods to grade responses, through specifying the feature procedure and features structure, the grading attributes and the grading procedure. One such embodiment provides a particularly simple, straightforward syntax by which to encode the grading procedure, as described further in F]2) below.

iii) Mechanics of the Grading Procedure.

In several embodiments, the grading procedure includes some or all of the following grading attributes, which the embodiments provide the user methods to specify:
a) a terms structure, including words, phrases and other textual and non-textual information, including formatting, location or order (the terms structure), intended to represent one or more concepts, and the relationship of the concepts to each other, that the user specifies to be indicative of a higher quality response,
b) associated numerical point counts for each term,
c) consistency assessment methods to assess consistency of a response with the terms structure specified in a) above, and
d) numerical association methods to associate a real number with each level of assessed consistency with the terms structure specified in a) above, based on the numerical point counts specified in b) above.

As indicated above, the user may specify these grading attributes on-line or off-line, in a word processing or RTF document, as described in greater detail below. The embodiments provide the user methods to upload grading attributes specified off-line and parse them into a machine-readable grading procedure. The grading procedure provides a response with (i.e. maps the response to) a numeric grade by searching or otherwise processing the features structure of the response (for example, the response text, the features list or the features array, as described to above) to assess the extent to which the features structure is consistent with (in Matching Embodiments, matches) the terms structure, using the consistency assessment methods in c) above. A response, the features structure of which matches sufficiently a specified terms structure, will be said to “reference” that terms structure. Based on the assessed consistency and numerical point counts in b) above, the grading procedure then provides a numeric grade for the response using the numerical association specified d) above.

For example, in one simple Matching Embodiment, as discussed in F]2) below, the terms structure comprises one or more lists of the terms included in each synonym group, one list for each synonym group. These lists are represented in raw text and have Boolean connectors, as described in greater detail below. The features structure is a list of the words in the response, also represented as raw text, possibly after stoplist or other filtering. A response is considered to match, and therefore to reference, a synonym group if at least one term in that synonym group occurs in the (raw) text of the features list. The grading procedure then provides a response with a numeric grade by searching the features structure of the response (the list of the words in the response referred to above) to see which synonym groups are referenced, and computes the arithmetic sum of the numerical point counts associated with each synonym group that is referenced. In this embodiment, a response references a synonym group if any member of the synonym group occurs in the raw text of that response. (In other embodiments, a response will be considered to reference a synonym group only if the both the text of at least one term in that synonym group and also other information, such as formatting, location or word order, occur in the response's features structure.) More specifically, this embodiment provides methods for the user to specify a list of one or more concepts, represented by lists of terms, and numerical point counts associated with each term. The numerical point counts are generally positive, but could be negative in the event the user believes a reference to the associated concept should represent a mistake that should be penalized. The user encodes the concepts in the terms structure by associating with each concept a list of one more terms comprising the associated synonym group. The user in turn encodes each synonym group by connecting the associated terms with the Boolean connectors “OR”, and connects the different synonym groups with the Boolean connector “AND.” The connector “OR” connects different terms that the user considers to refer to the same concept, and thus belong to the same synonym group. The connector “AND” connects different synonym groups.

For each synonym group, the user either provides a point count to be provided to a response that refers to any term in that synonym group, or, alternatively, provides separate point counts for each term in that synonym group. For each synonym group, the grading procedure searches a response's features for the terms in that synonym group, stopping with the first one matched, including found. Alternatively, if the user provided different point counts for different terms in the synonym group, the grading procedure searches the response's features structure for all the terms in the synonym group in order of their point counts, from highest (first) to lowest (last), stopping with the first term matched.

A response is then considered to reference appropriately a concept if at least one of the terms in the associated synonym group is matched in the response's features. The grading procedure determines a numerical point count for each appropriately referenced concept that equals the point count the user provided for the first term associated with that concept matched in the response features as described above. For each response, the grading procedure then determines a real number (the grade for that response) computed as the arithmetic sum of the numerical point counts for each concept that is appropriately referenced in the response.

Thus, this embodiment provides the user with a simple syntax for expressing the specified grading procedure that should be familiar to most users from the (different) context of Boolean search. This grading procedure follows a natural and intuitive machine-based implementation of the human process of grading by determining how many concepts from a specified list are referenced appropriately in a response. This grading procedure is based on the substantive content of the response, not on the quality of the English writing, grammar and style; accordingly, a response in the form of a short outline that references appropriately each specified concept could receive the maximum grade. To include a measure of writing quality and other more complex analyses of response quality, certain embodiments provide users methods to do some or all of the following:
1) provide reports (described in greater detail in D]4) below) for the user to review, showing the full graded response text with the appropriate references to each concept highlighted, together with methods to modify the grading procedure dynamically and flexibly for each task (such as a question) in the instructions to reflect such review, and to reapply the grading procedure as so modified to grade the response(s) anew,
2) modify manually (i.e. overwrite), in the report described in 1) above, the grading procedure's grade for responses to one or more particular tasks in the instructions (such as the answers to one or more particular questions), to reflect the user's review, without modifying the grading procedure,
3) specify the grading procedure to require complex interrelationships between the references to different concepts, such as through the proximity limits and other methods described above and immediately below, or
4) add as an overlay to the grading procedure standard measures of writing quality, including sentence length, part-of-speech (such as adjectives and verbs) analysis, spelling and grammar.

Other embodiments provide the user with methods to specify in the grading procedure a decision rule, such as a decision tree. In these embodiments, the numeric grade for a response may be determined based on the application of that decision rule to the different synonym groups referenced in the response. For example, the user might specify a grading procedure that required a response to reference at least two of three synonym groups, possibly within specified proximity limits, to receive a positive grade for any of the synonym groups. With such a grading procedure, the response must reference a plurality of concepts within a specified group of concepts for that response to be considered to have appropriately referenced any of those concepts.

Alternatively, the user might specify that a response that references all three synonym groups receives some specified amount less than 100% of the sum of the points counts associated with the three synonym groups, to reflect a certain amount of overlap in the associated concepts.

4) Analysis and Reports

Certain embodiments of the present invention provide the user with methods to create and review detailed grading reports, including analysis, of each responder's graded response, indicating the exact logical basis for the grade. The reports are available, and may be viewed on a plurality of bases, including by student or by question, and in summary or in detail. These embodiments also offers users generalized reports and analysis that may be shared with responders without disclosing sufficient detail to jeopardize the future use of the evaluation and/or the grading procedure, for example, by disclosing only user-specified labels for the concepts, without disclosing the actual synonym groups or associated terms. The reports and analysis may include reports or analysis tracking, monitoring or assessing some or all of the following
1) the performance of different responders on particular tests, assignments or other evaluations over time,
2) the performance of different responders on particular evaluations across instructors or institutions,
3) the performance of particular responders across different evaluations, in the same or different courses, or
4) the performance of particular responders across different evaluations over time.

The purposes of such reports and analysis may include tracking, monitoring or assessing some or all of the following
1) one or more responders' improvement or other progress over time,
2) one or more instructors' improvement or other progress over time,
3) the quality or effectiveness of
   a. tests, assignments, or other evaluations,
   b. educational materials or other materials, or
   c. teaching or instruction.

Consistent with the present invention's philosophy of seamless integration of on-line and off-line work, the grading reports may be reviewed on-line or off-line. Certain embodiments provides download methods to transfer grading reports from the system to a user's local machine, where they can be printed out in hard copy or reviewed electronically, or both, as the user prefers. These download methods provided by these embodiments are generally parallel to the upload methods described in D]2).—ENVIRONMENT, PLATFORM AND TRANSFER a)-d) above, with the direction reversed so the transfer is from the system to the user's local machine:
a) browser-based download,
b) drag-and-drop download,
c) email from the system to the user,
d) FTP or other standard file transfer from the system to the user's local machine.

These embodiments also provide the user methods to store the reports in a database, accessible by standard query procedures, and to share that database with one or more other users, evaluators, responders and/or institutions. In certain embodiments of the present invention for institutions, an institutional user specify that its associated individual users make the grading report databases available to that institution, by automatically saving all grading reports, and possibly also all evaluations and grading procedures, to secure storage areas on the institutions' systems, networks and/or computers.

Certain of these institutional embodiments offer the institutional user methods to customize the form and location of the report database and other information, so as to provide the institutional user a secure, real-time record of the performance of its associated individual users' activities on the system and therefore of the effectiveness of such activities. These embodiments offer educational institutions in particular real-time, detailed and comprehensive records of the effectiveness of the teaching of their instructors, as measured by the performance of the students of those instructors on every exam, quiz, test and homework assignment in every course. These records would comprise real-time databases with detailed information on each student's performance on each test and assignment question, updated immediately on the submission and again on the grading of each student's work.

5) Note on Rich Text Format

Quoting Wikipedia, “The Rich Text Format (often abbreviated to RTF) is a proprietary document file format . . . for cross-platform document interchange. Most word processors are able to read and write RTF documents.” Wikipedia, Rich Text Format, http://en.wikipedia.org/wiki/Rich_text_format, (as of Nov. 15, 2007, 9:18 GMT).

More information on Rich Text Format is available in the cited Wikipedia article and the materials referenced therein. It is safe to say that if a student, instructor or other user can create a document electronically on any platform, that document can almost always be saved in RTF format.

6) Additional Features

i) Automated Terms Structure Generation.

Certain embodiments of the present invention provide to a user methods to identify synonym groups and other terms structures partially or wholly automatically. One embodiment of the present invention provides a thesaurus or other “look up table” methods to the user to provide synonyms for terms that the user proposes, thereby assisting the user in expanding and completing a synonym group.

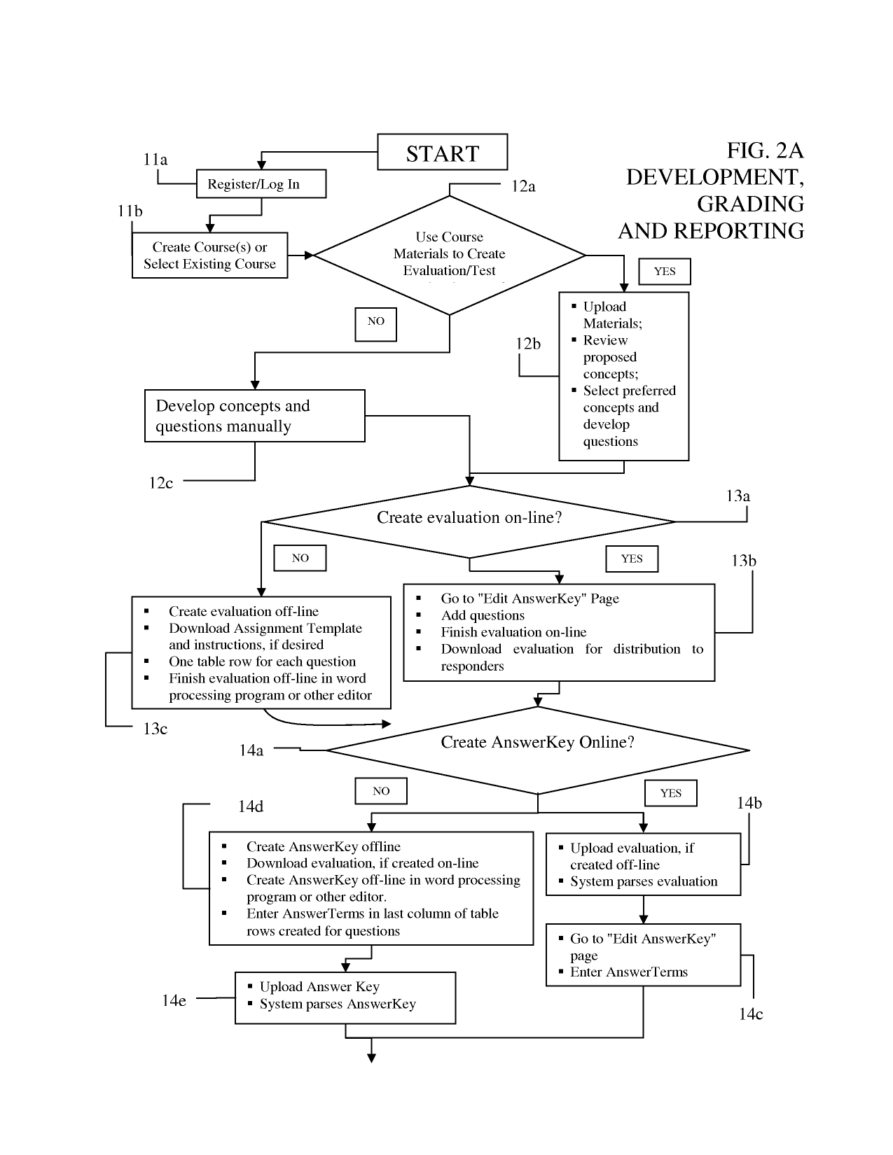

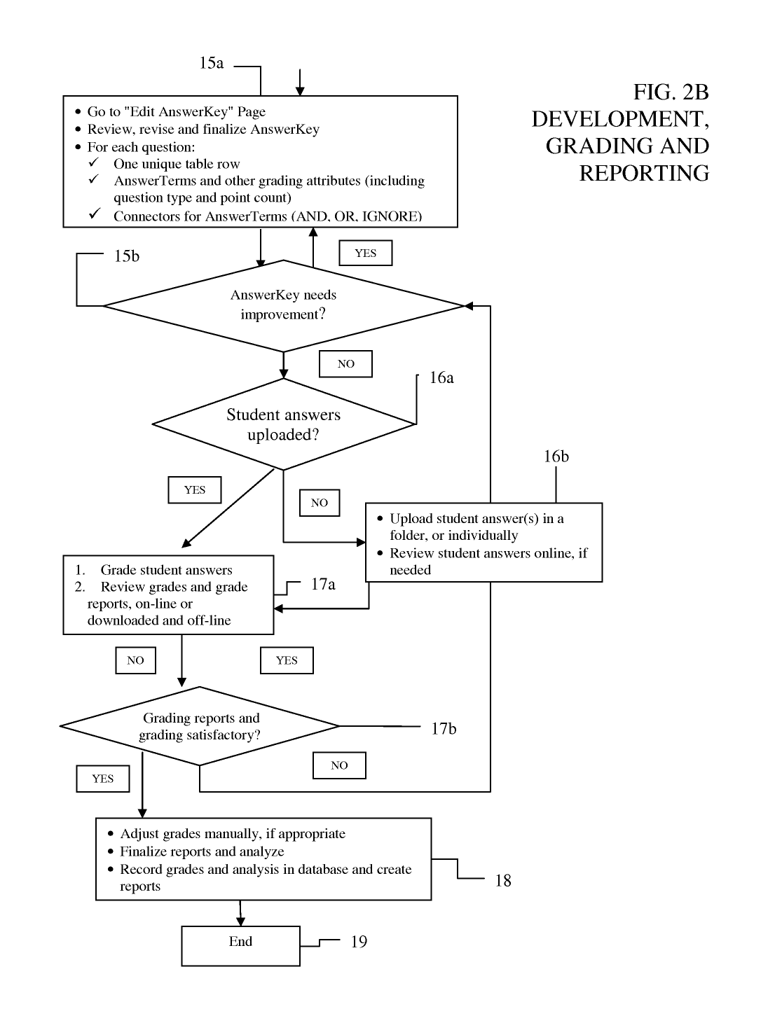

As shown in 12a and 12b of FIG. 2A in the Drawings, more sophisticated embodiments provide the user methods to upload or otherwise provide the relevant materials upon which, or materials otherwise related to the subject matter upon which, responders are to be tested, and terms selection methods to analyze those materials and to propose to the user promising terms on which to base terms structures, including synonym groups and associated concepts. The methods used by these embodiments find the terms in the materials with the greatest relevance to the content in which they appear, and have this general objective in common with “feature selection” in “[automatic] text classification.” See generally Yang & Pedersen, A Comparative Study on feature Selection in Text Categorization Proceedings of ICML-97, 14th International Conference on Machine Learning (1997.)

[1] Terms Selection.

Text classification comprises the automatic (i.e. machine-learning based) classification of a group of different documents or other different texts into different categories of content. Id. Starting with a given group of “training” texts that human classifiers have already classified into different specified categories of content, the art of feature selection in text classification provides methods to identify the terms (features) from those texts that are most effective at classifying the texts into the same different specified categories of content as were assigned by the human classifiers.

The application to DTGR is this. A question or other instruction that tests responders' familiarity with and understanding of materials or their substantive content, may be graded in part based on the presence, organization, location, order and formatting in the responses of references to terms from those materials that are particularly relevant to the materials' content. A response that omits any reference to such terms is unlikely to demonstrate familiarity with and understanding of those materials and their content. By contrast, a response that refers to many such terms is likely to demonstrate such familiarity and understanding. Identifying terms from the materials that are particularly relevant to those materials' content is the object of terms selection, which can be performed by humans or, as described below, in whole or in part by computer-based methods.

The objective of feature selection in text classification is somewhat different from terms selection in the pertinent embodiments of the present invention. The objective of feature selection is to identify terms the presence (or absence) and organization, location, order and formatting (for example, in quotes or italics, or as part of section headings) of references to which in a general text are strongly correlated with the classification of that the text into one or more of the specified categories. The objective of terms selection is to identify terms the presence (or absence) and organization, location, order and formatting of references to which in a general response are strongly correlated with familiarity with and understanding of particular substantive content discussed in materials.

In each case, however, the general objective of feature selection and terms selection may be viewed as identifying terms references to which make texts with the relevant content different from other texts without that content. In the case of text classification, the different texts are the texts in the different classification categories. In the case of terms selection, the different texts are responses that demonstrate familiarity and understanding of particular substantive content discussed in materials, on the one hand, and responses that do not demonstrate such familiarity and understanding, on the other hand, the former responses deserving a better grade than the latter.

Feature selection then uses the identified terms to classify text into different content categories. The pertinent embodiments of the present invention use the identified terms to propose to users synonym groups, and thus concepts (or other terms structures), upon which to test and grade responders on the relevant content. As discussed in greater detail below, many of the methods for feature selection in text classification may be modified to provide users new methods for concept selection, including identification of concepts and associated synonym groups. Certain embodiments of the present invention include such methods.

One embodiment of the present invention provides users terms for synonym groups by assigning scores to each term in the materials the user has provided, after stoplist filtering. The scores are based on multiplying the raw frequency of each term in the materials by a weight to produce a weighted frequency. (The frequency of a term in the materials is the number of occurrences of that term in the materials, or, alternatively, the number of such occurrences normalized by dividing by the total number of occurrences of all terms in the materials.) The embodiment provides methods for the user to select a unitary weight, namely a weight of one, corresponding to raw frequency, or one of a plurality of term weights that depend on the term. Whichever weighting scheme the user selects, the embodiment then provides methods to list the terms appearing in the materials in order of their scores based on that weighting scheme, and methods for the user to select the terms with the highest scores as representing concepts on which the user is likely to think responders should be tested and graded.

Specification of the method to determine the term weight will describe completely the method to determine the score. Under one choice for a term weight, the term weight (“logWeight”) equals the logarithm of the quotient of the term's frequency in the materials provided by the user, divided by the frequency of that term in a general corpus of written English, such as the “Brown Corpus.” See, e.g, http://en.wikipedia.org/wiki/Brown_Corpus (Nov. 20, 2007.) Symbolically,
score=(frequency in materials)*logweight, where
logWeight=log(frequency in materials/frequency in general corpus)

This weighting adjusts the frequency of terms found in the materials that the user provides by the frequency of those terms in written English language materials generally. The logWeight thus provides a measure of the comparative significance of the frequency of a term in the materials compared to its significance in general written English. A low frequency term in the materials might nonetheless be significant if its frequency in the general written English corpus were much lower, justifying a higher logWeight and a higher score. Conversely, a high frequency term in the materials might not be significant if its frequency in the general written English corpus were as high or higher, justifying a lower logWeight and a lower score. The embodiment provides to the user methods to select from the terms with the highest scores those that the user thinks most appropriate to represent concepts and associated synonym groups, upon which to test and grade responders. Other standard word corpora (other than the Brown Corpus) representing general written English may be used with equal ease and effectiveness by the embodiment's methods.

By way of background, the logWeight has certain elements that are generally similar to the “inverse document frequency” (“IDF”) in text classification. See, e.g., Salton, Wong and Yang, A Vector Space model for Document Indexing, 18 Communications of the ACM 11 (November 1975.) Text classification uses the IDF weighting scheme to select terms that effectively distinguish between different categories by appearing frequently in the texts in one category but infrequently in the texts of other categories. Unlike the IDF, however, the logWeight allows aggregation of many different texts into a standard corpus (such as the Brown Corpus) to create the weights, rather than requiring laborious, difficult and frequently impractical counting of term appearance in a large sample of documents classified into separate categories, as the IDF requires.

Certain embodiments of the present invention, described in greater detail below, provide methods to separate the text of materials provided by the user into disjoint units that provide the equivalent for these purpose of separate documents and document categories into which those documents have previously been classified, used for training in text classification. In one of these embodiments, the traditional IDF weighting scheme may then be applied to the separate disjoint units, in lieu of a general corpus of written English.

In addition to the IDF, there are many different weighting schemes used to multiply raw term frequencies that are part of the art of text classification, including but not limited to entropy, GflDF, Normal, Probabilistic Inverse, Signal-to-Noise Ratio and term Discrimination Value. See, e.g, Berry, M. & Browne, M. Understanding Search Engines at 38 (SIAM 1999); Korfhage, R. Information Storage and Retrieval at 114-125 (John Wiley & Sons, Inc. 1997.) These weighting schemes facilitate the determination of the significance of terms to the content of the text in which they appear, and thus also facilitate feature selection. As discussed above with respect to IDF, however, the schemes presuppose a group of different documents from which a matrix of term frequencies f(i,j) may be computed, where f(i,j) denotes the frequency of the ith term in the jth document. With multiple documents, a term may be weighted by a weight that measures the importance (through the frequency with which the term appears, or otherwise) of that term to the current document relative to its importance to other documents. Alternatively, in the basic text classification model in which the documents are to be classified into multiple different categories, the weight measures the importance of the term to the aggregate of the documents in one particular category, relative to its importance to the aggregate of the documents in the other categories. Such a weight may be determined, for example, by measuring, in any of several fashions, the frequency of the term in documents in the first category, relative to the frequency of that term in documents in the other categories.

In text classification, a term that occurs very frequently in the documents in a first category being analyzed for terms selection, but infrequently in the documents in other categories, is considered likely to be pertinent to the content associated with the first category. Applying this method to the different and novel context of DTGR, such a term may be considered likely to suggest a promising synonym group upon which to test respondents on their knowledge of the materials in that first category and the associated content. One problem with applying to DTGR these methods from text classification is that the user is not readily supplied with multiple documents or document categories to which these weighting schemes from text classification may readily be applied. In part for this reason, these weighting schemes have not previously been used widely in DTGR. But see Kakkonen, T., Myller, N., Timonen, J., & Sutinen, E., Automatic Essay Grading with Probabilistic Latent Semantic Analysis, Proceedings of the 2nd Workshop on Building Educational Applications Using NLP, 29-36, (Ann Arbor, June 2005) (applying a form of “Probabilistic Latent Semantic Analysis” to essay grading using a set of materials segmented based on, among other units, sentence and paragraphs.) Applying these weightings from text classification to DTGR requires invention of a method to provide either the equivalent of multiple documents and document categories, or to dispense with the need for them. A method to dispense with the need for multiple documents and document categories was described above with respect to the embodiment that included term weights based on a broad written English corpus, such as the Brown Corpus. Such a corpus acts in effect as an “all other” category, containing all documents in all categories. Although such a corpus also contains documents in the first category under analysis for terms selection, the influence on the corpus of the documents in the first category is small. The predominant influence on the corpus comes from documents in other categories, since they are so numerous.

[2] Equivalent of Different Categories; Information Gain

Without relying on a broad written English corpus, what is needed to apply the feature selection methods from text classification to DTGR is a method to provide to users the equivalent of different documents and document categories. Certain embodiments of the present invention include such methods to provide the equivalent of multiple documents and document categories, and therefore methods to apply to terms selection and concept selection the IDF weighting scheme discussed above, as well as the other weighting schemes, machine learning techniques and other feature selection methods.

In certain embodiments, the materials provided to the embodiment by the user exhibit a pre-existing separation or other organization, which then provides the equivalent of different document categories. For example, in the event those materials comprise a textbook or an extended academic article, or a portion of either, the textbook or article's table of contents separates the materials into discrete units (chapters or sections) that may be treated as different document categories for purposes of determining the term weights under the different text classification weighting schemes. If a table of contents is not present but the textbook or article has section headings, the headings may be used to create a table of contents and separation into units. If the textbook or article has neither a table of contents nor section headings, certain of these embodiments provide methods to create section headings automatically, by treating the text's separate paragraphs as separate documents and providing methods to identify terms with high frequency the occurrence or nonoccurrence of which in separate paragraphs create the clearest contiguous partition of the text (“automatic separation”), measured by entropy or weighting scheme, such as the IDF.

In the event the materials comprise a syllabus for an educational project, such as an educational course, the syllabus topics or unit headings provide the separation of the related materials under those topics or headings that in turn provides the equivalent of different documents and document categories.

In well-organized, well-written materials, the conceptual content of the units into which the materials may be separated represents appropriate organization of the conceptual content of the materials overall. Thus, identifying concepts and terms structures characteristic of the separate units should represent concepts and terms structures based upon which responders may effectively be tested on their familiarity and understanding of the materials overall, as well as unit by unit.

In these embodiments, the term frequencies then become f(i,j) where f(i,j) denotes the frequency of the ith term in the text of the materials in the jth syllabus unit, or the text in the jth article section or jth textbook chapter, as applicable. As described above, other embodiments simply create the equivalent of two documents or document categories: the materials provided by the user, on the one hand, and the Brown Corpus or other general written English corpus, as discussed previously with respect to the logWeight, on the other hand.

Once the materials the user has provided to these embodiments are suitably separated into disjoint units, equivalent to document categories in text classification, certain of these embodiments provide methods for term and concept selection based on the weighting schemes discussed above that are standard in text classification feature selection, although novel in DTGR. After uploading or otherwise providing to the system the relevant materials upon which responders are to be tested, and separation of those materials into separate sections, units or chapters, these embodiments that use weighting schemes provide the user methods to apply weighting schemes, including those in Berry & Browne and Korfhage cited above, by treating the texts of the different sections, units or chapters as in different categories, one category for each section, unit or chapter.

Other embodiments provide methods for the user to use the machine learning techniques known in the art of text classification, including some or all of the following: information gain (a method based on Quinlan, cited above), chi-squared ranking and cluster analysis. Although not based on term weighting schemes, these machine learning techniques are also a standard part of the art of text classification and feature selection. For a summary of certain of these methods, see, e.g., Yang and Pedersen, cited above.

An illustration of certain embodiments' methods for identifying promising terms using information gain appears below; although it is part of the prior art of text classification, I describe it in some detail because its use in DTGR is novel, and because it includes an additional step of separating the separate units into the equivalent of separate documents. See generally Yang & Pedersen, supra, at Section 2.2.; Manning, Raghavan & Schutze, An Introduction to Information Retrieval (Preliminary Draft, 2007, available on line at http://www-csli.stanford.edu/˜hinrich/information-retrieval-book.html.) Several alternative criteria related to information gain and mutual information may also be used, including the “information gain ratio”, the “coefficients of constraint” (Coombs, Dawes & Tversky 1970), the “uncertainty coefficient” (Press & Flannery 1988) and “absolute mutual information” based on Kolmogorov complexity. Several embodiments include methods of identifying promising terms using these related criteria, which are also well known in the art of text classification and automatic decision tree building. See, e.g., http://en.wikipedia.org/wiki/Mutual_information; http://en.wikipedia.org/wiki/Information_gain_in_decision_trees (Dec. 26, 2007).

To illustrate the methods of the embodiments referred to above for terms selection using information gain, assume that a joint probability distribution is given for terms and for the units (or subunits) into which the materials are separated. For each term, the “expected information gain” is then the Kullback-Leibler divergence of (a) the joint probability distribution of the units and the occurrences of that term, from (b) from the product of the marginal probability distribution of units and the marginal probability distribution of those occurrences. Kullback S., Information Theory and Statistics (Dover 1997); McKay, D., Information Theory, Inference, and Learning Algorithms 143, Equation 8.27 (Cambridge University Press 2003.)

More specifically, the expected information gain I(X;Y) between two random variables X and Y is defined as follows, where
X takes a set of values {x},
Y takes a set of values {y},
P denotes probability,
P(x) and P(y) denote respectively the probabilities P(X=x) and P(Y=y), and log2 denotes the logarithm to the base 2.

(I1) Definition: I(X:Y)=
Sum over (x) [P(x)*log2(1/P(x)]+Sum over (x,y) [P(x,y)*log2(P(x,y)/P(y))]=

(I2) Sum over (x,y) [P(x,y)*log2(P(x,y)/(P(x)*P(y))].

From (I1): I(X:Y) may be thought of as the expected residual uncertainty in X after Y is known.

From (I2): I(X;Y) is symmetric in X and Y. The expected information gain I(X;Y) is also referred to as the “mutual information” between X and Y, terminology justified by this symmetry. (I2) demonstrates the mutual information can be expressed as Kullback-Liebler divergence. See, e.g., http://en.wikipedia.org/wiki/Information_gain_in_decision_trees (Dec. 26, 2007).

To use expected information gain as a criterion in terms selection, we seek among all the terms in all the units, those terms with the highest information gain relative to the units, as described above. These will be the terms that, by predicting the separation of the units optimally in the sense of information gain, represent promising synonym groups and concepts upon which to test respondents on their knowledge of the materials. Computing the information gain requires a specification of a joint probability distribution of terms, units and subunits, as described below.

Certain embodiments of the current invention use the following method to specify such a joint distribution. Given a separation of the materials into units, let N be the number of units into which the materials have been separated and the event X be the occurrence of the xth unit, where x=1 . . . N.

To apply the method requires a further subdivision of the separate units, themselves the equivalent of document categories, into separate subunits, the equivalent of separate documents within a document category. This method uses the separate paragraphs of each unit as a default for the subunits, but permits the user to choose alternatives, such as specified subsections of the units or other subunit specification (such as sentences or automatic separation, described in above this section.) Given a subunit, let the event Y be that the term occurs, or does not occur, in that subunit.

The method proceeds term by term, analyzing sequentially each term that meets certain minimum thresholds of overall term frequency, after stoplist or other filtering. The method assigns to the event that both a given unit occurs and the term (“T”) under consideration occurs in that unit (i.e. P(X=the given unit x, Y=the term T occurs)=by definition P(x,T)) a probability equal to the quotient of the total number of subunits (paragraphs by default) in the given unit in which the term actually occurs, divided by the total number M of subunits in all units. Having defined P(x,T), all the other relevant probabilities may be determined by the standard rules of probability. We provide some of these determinations explicitly for convenience. The method assigns to the event that the unit occurs but the term does not occur in that given unit (i.e. P(X=the given unit x, Y=term does not occur)=by definition P(x,˜T)) a probability equal to the quotient of the number of subunits in the given unit in which the term does not occur, divided by M. The method also assigns to the event that the term occurs (i.e. P(Y=term occurs)=by definition P(T)) a probability equal to the quotient of the number of subunits in all units in which the term occurs, divided by M. The method assigns to the event that the term does not occur (i.e. P(Y=term does not occur)=by definition P(˜T)) a probability equal to the quotient of the number of subunits in all units in which the term does not occur, divided by M. Finally the method assigns to the event that a unit x occurs (i.e. P(X=the given unit x)=by definition P(x)) a probability equal to the quotient of the number of subunits in x divided by M. Since the units are disjoint and together comprise the materials, there is no need to compute separately the probability that a unit does not occur.

Using (I2) above, I(X;Y) is a sum over unit-term pairs (x,T) and (x, ˜T) of various summands. To compute these summands, take each unit x and compute P(x,T) and P(x,˜T). The former equals #|subunits in x in which T occurs|/M. The latter equals #|subunits in x in which T does not occur|/M. (For any set A, #|A| denotes the number of elements in A.)

P(x,T) is associated with the summand:
P(x,T)*log2(P(x,T)/(P(x)*(P(T))).

P(x,˜T) is associated with the summand:
P(x,˜T)*log2(P(x,˜T)/(P(x)*(P(˜T))).

I(X;Y)=(the expected information gain of the unit separation and the term) is then the sum over all unit-term (x,T) and (x,˜T) pairs of the summands above.

Since the unit and subunit separation are given, I(X,Y) is a function of the particular term selected. To identify the most promising terms for synonym groups, the relevant embodiments' methods list the terms in order of the associated expected information gain for each term, from highest to lowest, and provide the user methods to select those terms the user finds most promising.

As one skilled in the art of text classification will readily appreciate, the embodiments described above may easily be modified to incorporate different bases for determining the units and subunits, and different criteria for suggesting promising synonym groups, concepts and other terms structures upon which to test respondents on their knowledge of the materials.

[3] Term Expansion.

The methods of the embodiments described above apply text classification feature selection techniques to terms selection, to identify synonym groups, concepts and other terms structures to use in evaluations. Other embodiments include methods to expand a synonym group, concept or other terms structure by term expansion, including suggesting new terms to include in the given terms structure. Once separate chapters, sections or other units, and subunits, of the materials, along with the initial terms, have been provided by the user, these embodiments provide methods to find other terms distinct from the initial terms that classify the units and subunits in a similar manner to the initial terms.

These methods comprise two steps. In the first step, the methods apply the terms selection methods described above to identify new terms other than the initial terms. In the second step, the methods provide, for each of the initial terms, the new terms that classify the specified units or subunits in a similar manner as the initial terms. In one such embodiment, the determination of similarity is made based on “mutual information”, in a manner similar to that described above with respect to terms selection. This embodiment provides, for each initial term and new term, methods to compute the expected information gain from the units or subunits based on the initial terms conditioned on the new term. The new terms are then ranked based on this mutual information.

Another embodiment provides methods to create a specialized thesaurus from the materials the user provides, by identifying terms that efficiently classify the units or subunits and treating as synonyms terms that classifying the units or subunits similarly. This method identifies terms that are conceptual synonyms, in the sense that they identify the same sections or chapters of the materials and thus identify the same concepts, although they may not be synonyms in the conventional English sense of the word “synonym.” Other methods that are standard in text classification may be modified in the same general manner as described above to apply to DTGR. Such methods include statistical correlation, latent semantic indexing and clustering. See, e.g, Landauer, T. K., Foltz, P. W., & Laham, D. Introduction to Latent Semantic Analysis. 25 Discourse Processes 259 (1998).

[4] Large Scale Training.

For many evaluators without access to either
a) training examples, including large numbers of previously graded responses,
b) materials related to the substantive content on which those responses or other examples were graded, and/or
c) the terms structures used in grading the training examples,
   methods based on extensive review of training examples may not be practical.

However, for evaluators with such access, certain other embodiments of the present invention provide methods to use the machine learning techniques that require large scale training on many examples for which grades and/or terms structures have been specified. These methods may include either, or both, of the following: latent semantic analysis and support vector machine methods.

Latent semantic indexing in the context of information retrieval and storage is discussed in U.S. Pat. No. 4,839,853. See also Landauer, T. & Laham, D. Introduction to Latent Semantic Analysis, Discourse Processes, 25, 259-284 (1998); See also Kakkonen, T., Myller, N., Timonen, J., & Sutinen, E. Automatic Essay Grading with Probabilistic Latent Semantic Analysis, Proceedings of the 2nd Workshop on Building Educational Applications Using NLP, 29-36, (Ann Arbor, June 2005) (grading essays by comparing their text to the latent semantic content vectors of other texts and previously-graded essays.) Text classification using support vector machines is discussed in Shawe-Taylor, J. & Cristianini, N., cited in C]2)vi)[2] above. Certain embodiments provide methods to apply these large scale methods, and other large scale methods from prior art, using the examples and materials from a) and b) above to identify terms, associated synonym groups and other terms structures from the materials that best predict the actual grades given in the training examples. Other embodiments provide methods to apply these large scale methods to the examples, materials and terms structures from a), b) and c) above to identify the combination of the term frequency (raw or weighted), together with term location, order and formatting in the materials that best predict the terms structure for the training examples, thus developing a method predicted to identify promising terms structures automatically from new materials.

Relative to the large-scale methods that are part of prior art, including the methods described in Landauer et al., Kakkonen et al. and Shawe-Taylor & Cristianini, cited above, the significant improvement of the pertinent embodiments of the present invention is 1) methods to provide in DTGR the equivalent of multiple document categories, and based on these methods, 2) methods to use the text classification feature selection methods to identify terms structures from the materials provided by the user, rather than, for example, to grade responses directly based on their similarity to the those materials or to the graded training examples. Terms structures allow simpler and more flexible user review and modification than direct grading, which relies on complex “black box” grading methodology. See C]2)vi)[1] above. Grading essays based on textbook extracts has been found less effective than methods based on a pre-graded essays. Kakkonen et al., 3.

However, although not preferred, in certain embodiments, the large-scale methods from prior art referred to above may be incorporated into the system and methods of the present invention to grade essay and other essay-type questions, while retaining the innovation and advantages of the present invention's other methods, procedures and other components.

ii) Grade Adjustment for Spelling Errors.

In certain embodiments, the present invention provides to the user methods to treat a response as referencing a term in a synonym group or other terms structure if the response's features structure includes a misspelled item, such as a string or other item that is different from but sufficiently close to that term, and to provide an adjustment to the grade associated with that synonym group to reflect the extent of the difference between the misspelled item and the term. In certain of these embodiments, the difference between a misspelled item and a term is determined by the edit distance (also known as the “Damerau-Levenshtein” distance) between the associated raw text strings. This embodiment provides methods for the user to
a) specify the maximum distance between a features structure item and a term in a terms structure at which the associated response will still be considered to reference the term (and above which the responses will not be so considered), which distance may vary for different terms,
b) specify whether that distance will be determined with or without regard to case (i.e. capitalization), format or other features,
c) specify how to reduce the grade associated with a misspelled item to reflect the distance between that item and that term.

To provide more efficient execution, the embodiment's determination of distance terminates once the maximum distance specified by the user in a) above is reached. A code sample of one example of these methods for determining the edit distance appears in the Code Listings accompanying this Patent Application.

Instead of the edit distance, another embodiment provides the user methods to compare an item in the features structure with a term in a terms structure by measuring efficiently:
a) the overlap distance, including the number of characters in common between the item and the term and therefore also the number of different characters between the item and the term, and
b) the order difference, including the difference in order between the common characters in the order appearing in the item and the order appearing in the term.

The overlap distance is based on the number of common characters and the number of characters not in common in each of the features structure item and the term, and can be determined in different ways.

These embodiments provide methods for the user to specify the determination of the overlap distance. For example, the user might specify that this distance is the absolute value of the difference between the number of common characters and the average number of total characters in both the item and the term, or the quotient of this difference and such average number of total characters.

These embodiments also provide the user methods to specify the maximum acceptable value of each of these two distances, together with methods to combine the overlap distance and the order distance into a single distance, and methods to adjust the grade point count to reflect both distances, or the single combined distance.

The order distance is the minimum number of transpositions (i.e. switches) of adjacent characters needed to put the common characters in the features structure item in the same order as the common characters in the term. The methods to determine the order distance includes the following procedures. The discussion considers first the easiest case where all the common letters are unique, which is to say that no common letter is repeated in either the features structure item or the term.

To illustrate this method, consider an example where the features structure item is “acre” and term is “gear.” The common letters are “are.” The overlap distance could be chosen to be 1 (computed as 4−3) out of 4, where 4 is the average number of letters in the item and the term and the number of common characters is 3. The method to compute the order distance would include some or all of the following steps.
a) First, write down the common letters in order in the features structure item. Assign each letter an integer representing the location where it first appears. This is possible because the letters are assumed to be unique. In the example, the resulting numbering would be: a=1, r=2, e=3.
b) Second, write down the common letters in their order in the term as a sequence of integers, using the numbers derived in the previous step. In the example, the result would be 3=e, 1=a, 2=r.
c) Count the total number of adjacent and non-adjacent pairs in the term that are in the wrong order. In the example, two of the three pairs are in the wrong order (3,1), (3,2), but not (1,2).
d) Find a pair of adjacent numbers in the synonym group member sequence in the wrong order. There must be such a pair if the two sequences are in different order, since the numerical ordering is transitive: if a<b and b<c then a<c.
e) Switch that pair. Doing so reduces the total number of pairs in the wrong order by 1. In the example, the first adjacent pair (3,1) may be switched, leaving (1,3,2). Now only one of the three pairs is in the wrong order.
f) Continue. At each stage, the total number of pairs in the wrong order is reduced by one, so the method terminates when the common characters in the term are placed in the same order as in the features structure item. In this case, a single additional switch puts the common characters in the term in the right order (1,2,3). Thus, the order distance is two.

In case letters are repeated, the same method can be applied after first treating repetitions of a single letter as different letters, numbering them from left to right. Thus, “acreage” would be number a=1, c=2, r=3, e=4, a2=5, g=6, e2=7. The same method can then be applied, and is effective because switching two identical letters is clearly inefficient.

One issue can arise if certain of the common characters are repeated more frequently in one of the two strings (the features structure item and the term, each, for purpose of the remainder of this subsection, a “word”) than in the other. Consider, for example, words “acre” and “acreage”. The common characters are “a”, “c”, “r” and “e” (in the order they appear in the first word), but “a” and “e” appear twice in the second word. If the second occurrence of “a” and the first occurrence of “e” are taken from the second word, the result is “crea”, which is an order distance of 3 from “acre.”

Certain embodiments of the present invention provide methods in these circumstances to select the common characters from the word with more occurrences of those characters in a manner to minimize the resulting order distance. These methods include a procedure that begins by creating two strings of characters, one for each word, by writing, for that word, all occurrences (not just the number of common occurrences) of each of the common characters, in the order of those occurrences in that word. In the case of “acreage”, this would produce the string “acreae.” In the case of “acre” this would produce “acre”. The procedure applies sequentially to each character repeated more often in one string than the other. To describe the procedure further, let us assume first there is a single character, is denoted by “<c>”, that is repeated (M) times in one string (the “longer string”) and only (N) times in the other (the “shorter string”), with M>N, and the other characters have the same number of occurrences in both strings. The procedure selects the subset of N occurrences of <c> in the longer string that, when the other occurrences of <c> are deleted, results in a substring the minimum order distance from the shorter string.

This subset of occurrences of <c> in the longer string resulting in the minimum order distance from the shorter string will be referred to as the “minimum distance subset” and the associated order distance the “minimum distance.” For each common character <c>, the procedure finds the minimum distance subset by determining the order distance under two alternative assumptions, recursively, and picking the assumption which produces the smaller order distance, a form of dynamic programming.

The first assumption is that the last (i.e. final) occurrence (counting from left to right) of the character <c> in the longer string is included in the minimum distance subset. In that case, the last occurrence of the character <c> in the shorter string must be “matched” with the last occurrence of <c> in the longer string, because, very generally, those last occurrences must each be matched with some occurrence of <c> in the other string, and if they are not matched with each other, the matching will cross, creating additional order distance. In the very specific context of this subsection ii), “matched” means “moved to” under the sequence of switches (transpositions) corresponding to the order distance. Under this assumption, then, the minimum distance subset is the last occurrence of <c> in the longer string, together with the minimum distance subset determined by comparing all occurrences of <c> but the last in the shorter string with all occurrences but the last in the longer string.

If the first assumption is not true, then the minimum distance subset excludes the last occurrence of <c> in the longer string. This is the second assumption. In that case, the minimum distance subset is same minimum distance subset as results from comparing all the occurrences of <c> in the shorter string with all occurrences of <c> but the last in the longer string.

The recursion continues until either the two strings have the same number of occurrences of <c> (since the second assumption eliminates one occurrence from the longer string) or there is a single occurrence of <c> in the shorter string (since the first assumption reduces the number of occurrences of <c> in both the shorter and longer string), in either of which cases the minimum distance subsets and minimum distance may be determined directly.

In the case where there are multiple characters repeated more times in one word than the other, the procedure proceeds as above with each such character sequentially, creating an enumeration, in the form of a tree, of possible minimum distance subsets for all the characters, and finding the one that produces the minimum order distance. The procedure starts, for example, by selecting one of the two words, starting at the beginning and proceeding one character at time from the beginning towards the end of that word until the first character is encountered that is repeated a different number of times in one word than in the other. The procedure then continues as above with respect to that character enumerating the potential minimum distance subsets for that character, after which the procedure proceeds to the next character in the selected word. The principal additional complexity is that the order distances associated with the various potential minimum distance subsets cannot be known until the process has ended.

### EXAMPLES

In the case of “acre” and “acreage”, the longer string is “acreae”. Using the method described above, and starting with “acre”, the first character repeated a different number of times in the two strings is <a>. If the first <a> of “acreae” is included in the minimum distance subset, the two resulting string would be “acre” and “acree.” If the second <a> of “acreae” is included, the two resulting strings would be “acre” and “crea.” The next character repeated a different number of times in the two strings is <e>. If the first <a> and the first <e> are selected, the resulting two strings would be “acre” and “acre”, with an order distance of zero. Since zero is clearly the minim order distance, the process stops.

Note that the minimum distance subset is not unique: the first <a> and the second <e> from “acreae” also results in the string “acre” and a zero order distance. Little recursion was needed, very generally, because one word (namely “acre”) contained no duplicates of the common characters. These two words accordingly represent a very easy case, but fortunately a common one, given the potential computational complexity of recursion.

Consider alternatively a more complex example consisting of the two words “gear” and “acreage.” Since <c> only occurs in the second word, the two strings of common characters, including duplicates, would be “gear” and “areage”. Starting the process with the first string, “gear”, there is exactly one <g> in both strings. The second character, <e>, occurs twice in the second string but only once in the first string. If the last <e> is included in the minimum distance subset, the two strings would be “gear” and “arage”. If the first <e> in the second string is included, the two strings would be “gear” and “areag.”

The next character in the first string is <a>, which occurs twice in the second string but only once in the first string. If the last <a> in is included in the minimum distance subset, the two string would either be “gear” and “rage”, a order distance of 5, or “gear” and “reag”, also an order distance of 5. If the first <a> in the second string is included, the two strings would be “gear” and “arge”, an order distance of 4, or “gear” and “areg”, an order distance of 5. Thus, the minimum distance subset consists of the last <e> and the first <a> in the second string, for a minimum order distance of 4.

A code sample of this method for determining a somewhat simpler concept of minimum distance and minimum distance subset appears in the Code Listings accompanying this application. In this code sample, the distance between an identical number of (N) occurrences of the same character in a two strings is defined as follows. Index the occurrences of the character in each string from left to right in increasing order by (i), where “i” denotes a positive integer, i=1 . . . N. Then the distance between to the two (sets of) occurrences is defined as the sum over (i) of |p(s,i)−p(I,i)|, where p(s,i) is the position of the ith occurrence of the character in one string, and p(l,i) is the position of the ith occurrence of the character in the other string.

“∥” denotes mathematical absolute value. An example, described above, would be a subset of (N) occurrences of <c> in a longer string and all the (N) occurrences of <c> in a shorter string. Thus, the distance between the occurrences of <e> in “gear” and “rage” would be |4−2|=2, and of <a> in “acreage” and “garage” would be |2−1|+|5−4|=2. This simpler concept of distance functions as an approximate, though inexact, proxy for order distance.

iii) Plagiarism Testing.

Using the features structures, certain embodiments of the present invention provide novel, practical and useful plagiarism testing methods for testing for plagiarism in responses, whether among the responses or from outside materials. For these purposes, plagiarism includes one or more responses that have been wholly or partially copied or otherwise plagiarized from other responses or from outside materials. Outside materials include readily available articles or reference materials, or any portion or entries thereof or therein, textbook extracts, or circulating “canned” answers.

By modeling probabilistically the terms used in an arbitrary response's features structure (using Zipf's law or otherwise), features structures derived from actual responses may be considered to represent samples from the probability distribution underlying the model. The probability distribution selected may be any one of a standard group of probability distributions used in modeling linguistic processes and related processes.

In several embodiments, methods are provided to the user to model the term frequencies in features structures using any one of a standard set of probability distributions, including normal, lognormal, binomial, multinomial and Poisson distributions. These embodiments provide the user methods to select the probability distribution, and to use the features structures from actual responses to estimate statistically the parameters of that probability distribution, based on standard statistical methodology. Thus, the parameters of the probability distributions underlying the model of the terms in features structures may be estimated based on the samples that the response features structures represent.

Based on these estimates and standard statistical methodology, the probabilities of the similarity of the responses' features structures to each other may be determined, as well as the similarity of those features structures to features structures derived from outside materials. From these probabilities, certain embodiments of the present invention provide methods to estimate statistically the confidence that plagiarism has occurred between two responses, or between a response and outside materials.

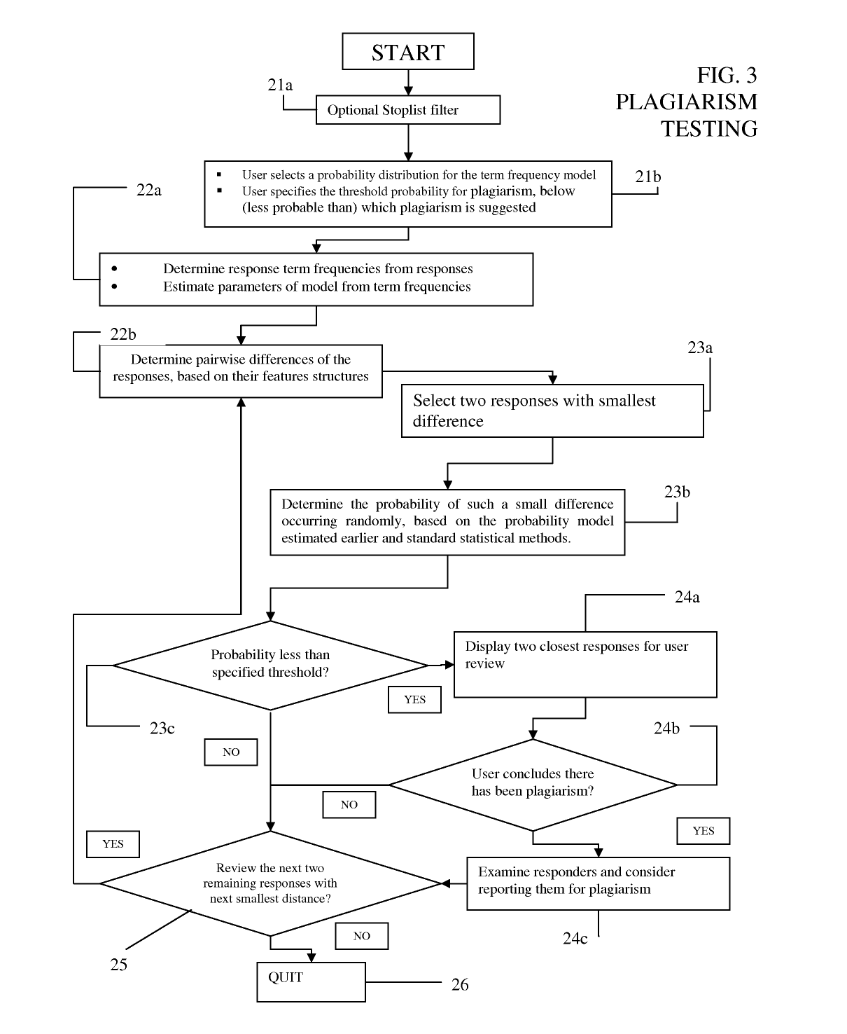

FIG. 3 in the attached Drawings describes a broad overview of the plagiarism testing methods in certain embodiments of the present invention. More specifically, in several embodiments, the plagiarism testing methods include some or all of the following steps:
a) First, the frequencies of the terms (after stoplist filtering, if selected by the user, as shown in 21a) in each features structure derived from each response are determined. In certain embodiments, the features structure is the full text of the response.
b) The terms derived from all the features structures are aggregated to determine a common terms “universe”.
c) A probabilistic model for generating features structures is derived based on the probability distribution(s) the user specifies for the universe, as shown in 21b of FIG. 3.
d) The parameters of that probability distribution(s) are estimated statistically from the features structures of the responses, as shown in 22a of FIG. 3. As a very simple illustration of such a model and such estimation, the probability of the term “Beethoven” occurring at least once in an arbitrary features structure might be estimated to be 10%, if it occurred in one out of every ten features structures associated with actual responses.
e) For each pair of features structures, the difference between the frequencies (number of occurrences) of each term in the each of the two features structures is determined by subtraction, as shown in 22b of FIG. 3. The squares (or other strictly positive function such as the mathematical absolute value) of the differences are summed to determine a measure of the distance between the two features structures, viewed as vectors in a Euclidean space. Certain embodiments include other distance measures, including some or all of the following: (1) the vector distance between the two features structures, again viewing each features structure as a vector, and (2) a distance measure based on one or more weighting matrices, including weighting matrices based on estimated covariances of the terms in the features structures.
f) Among all the pairs of features structures, as shown in 23a of FIG. 3, the methods identify the pair that is the closest, i.e. the smallest distance apart among all pairs of features structures. Based on the probability distribution, the parameters of which were previously estimated in step d) above, the methods then determine the probability (the “distance probability”) that the distance between this pair of features structures is no larger than it is, as shown in 23b of FIG. 3. Where possible, exact computations are provided but in many cases Monte Carlo or other numerical estimation procedure must be performed to estimate the distance probability.
The distance probability is a statistical measure of the likelihood that any similarity between the features structures resulted from chance. The greater the distance between two features structures, the higher the distance probability, and the greater the likelihood that any similarity between those features structures resulted from chance, and the lower the likelihood that the similarity resulted from plagiarism.
One problem to be surmounted is the following. The two responses (the “Minimum Distance Responses”) most likely to result from plagiarism are the two responses with the closest features structures. The determination of the distance probability for these two responses must take into account the constraint that the pair of Minimum Distance Responses was deliberately selected to have features structures the smallest distance from each other. In particular, the resulting probability will be higher than if the two responses were selected at random. The embodiments that provide plagiarism testing solve this problem, including by using the geometric symmetry of the features structures, viewed as vectors, and of the probability distribution, to reduce the problem to an unconstrained problem
g) All pairs of responses and associated features structures having the distances apart determined in step e) above are then reported to the user in order of increasing distance between the features structure pairs, as shown in 24a, 24b, 24c and 25 of FIG. 3. The distance probability of the Minimum Distance Responses is also reported to the user. Based on that probability and the user's inspection of the Minimum Distance Responses, the user determines whether plagiarism is likely to have occurred, as shown in 24b. If the user concludes that it is, the embodiments provide the user methods to determine the distance probability for the pair of responses among the remaining pairs of responses having features structures that are the closest (excluding the pair of Minimum Distance Responses), as shown in 25 in FIG. 3, and to determine distance probabilities for other pairs of responses the user specifies.

Certain embodiments of the present invention thus provide the user methods to review all the pairs of responses in order of the probability that they resulted from plagiarism. These methods may easily be modified to determine the probability that a response was plagiarized from outside materials.

E] Business Model

The business model of the present invention may include some or all of the following features.
A. Subscriber fees from individual users determined by a formula based on the number of responses the user expects to grade during a specified period, subject to a generous overall limit on the total number of individual questions or tasks that will be graded.
   The user can buy a minimum limited package, for example, 250 responses to be graded during a semester, and additional responses in specified blocks, say, an additional 50 responses to be graded during the semester. These graded responses may be distributed between courses and assignments in whatever manner the user prefers. A total cap of 2,500 questions/tasks for each block of 50 responses would also apply.
   Alternatively, for a significantly higher fee, the user can buy an unlimited package, providing the right to grade an unlimited number of responses during the specified period, subject to a very high maximum cap on the total number of questions/task.
B. A free or reduced-fee trial period for users.
C. A group discount with breakpoints for groups of individual users.
D. In certain circumstances, a partial rebate of fees to the extent the actual usage of the system is less than user expected.
E. License fees from institutional users employing multiple individual evaluators or with whom multiple individual evaluators are associated. The amount of the fee would be determined by a formula based on the total number of evaluators covered by the license, the type of license, the period over which the license extents, and subject to one or minimums, such as either or both of the following.
   To specify the type of license, the institution would specify which evaluators of the total number of the institution's evaluators covered by the license would receive an unlimited package and which evaluators would receive a limited package, each as described above.
   The institution would be required to acquire an unlimited package for a minimum number of evaluators.
F. A negotiable fee for certain institutional evaluators, such as a testing service, a licensing authority or the armed services, covering a potentially broader package of services for all the evaluators' responders over a specified period. The broader package of services could include some or all of the following: creation of customized evaluations, customized grade analysis and customized storage and retrieval of grades and analysis.
G. For publishers of print and electronic materials, including textbooks, a negotiable fee schedule based on expected usage, with breakpoint discounts for high volumes. The fee could include a customized service based on the system with some or all of the following features:
   A limited service offered to instructors that use the publishers' materials in courses they teach. These instructors would be able to use the system to grade their students' responses to problems, questions and other tasks in the materials. The grading procedures would be provided automatically as part of the service, but could be editable by the instructor.
   A broader service offered to instructors that use the publishers' materials in courses they teach, subject to a higher fee. In addition to the limited service described above, these instructors would be provided with prepared assignments, tests, quizzes, exams and other evaluations based on the subject matter in the materials, but not included in the materials, and would be entitled to use the system to grade those evaluations. The grading procedures would be provided automatically, but could be editable by the instructor.
   An additional service offered to instructors that use the publishers' materials in courses they teach to use the system to create and grade evaluations in those courses.
   A limited service offered to purchasers of the publishers' materials, including students, who would be entitled to use the system to grade problems, questions and other tasks in the materials. The grading procedures would be provided automatically. These purchasers might also receive comments on how to improve their responses through indications of the concepts the purchasers' responses omitted that resulted in receipt of less than the highest possible grade.
   A broader service to purchasers of the publishers' materials, including students, who, in addition to the limited service described above, would be entitled to use the system to grade prepared assignments, tests, quizzes, exams and other evaluations based on the subject matter in the materials, but not included in the materials. The grading procedures would be provided automatically. These purchasers might also receive comments on how to improve their responses through indications of the concepts the purchasers' responses omitted that resulted in receipt of less than the highest possible grade.
H. Users that use the plagiarism testing methods provided by certain embodiments may be charged an additional fee for the use of those methods. These fees may be discounted, including to zero, based on the amount of grading and other methods those users are otherwise using and the corresponding amount of fees they are otherwise paying. For example, the institutional users described in E above paying substantial fees for a significant number of their associated individual evaluators to use the grading and reporting methods of the present invention may obtain the plagiarism testing methods at a reduced fee, or even at no cost.

### F] CERTAIN EMBODIMENTS OF THE PRESENT INVENTION

### 1) Embodiments Including Tests and Assignments

In certain embodiments, the instructions comprise questions to answer, including some or all of the following:
(a) problems to solve,
(b) essays or answers to type or write,
(c) answers to select or identify (as in, for example, multiple choice or true/false questions), or to complete or otherwise provide, and
(d) exercises and/or other tasks to complete.

One or more questions may be combined and presented as an evaluation comprising a test, including some or all of the following: homework assignments, other assignments, problem sets, essays, exercises, projects, quizzes, tests, mid-terms and exams. A question may, but need not, include instructions to write essays or long or short essay answers.

i) Methods for Documents

Certain of these embodiments include methods for one or more evaluators or other users to develop evaluations comprising one or more documents (whether electronic or physical, and whether created and distributed locally or remotely, through one or more networks, environments or platforms, or otherwise), which may contain one or more other (sub)documents, pages and/or references, by which to test the capacities of one or a plurality of responders by some or all of the following
a) including one or a plurality of questions in those documents,
b) transmitting or distributing, physically, electronically or otherwise, the documents to the responders, including without limitation any of the following types of transmission or distribution:
   a. physical or electronic transmission or distribution, including without limitation through physical mail, other physical delivery or distribution, electronic mail or other electronic distribution, or
   b. transmission or distribution by making the evaluations available to the responders, physically or electronically through software and/or or through a network such as the Internet, World Wide Web or local intranet, including through a platform or environment available on such a network, including an OEP, or
   c. transmission or distribution, physically, electronically or otherwise, of one or more references to questions contained or included in sources that are otherwise available (physically, electronically, locally or through one or more networks, environments or platforms, or otherwise), including but not limited to Webpages, textbooks, workbooks, lecture notes, problem sets or exercise books, or
   d. otherwise transmitting or distributing the documents, and
   c) grading the responders' responses, using electronic methods, and
   d) analyzing and reporting the results of the grading, including the grades and such analysis, to one or a plurality of persons, including but not limited to one or more responders.

ii) Evaluators May Include Educational Instructors.

In certain of these embodiments, the evaluators may be educational instructors that develop tests and assignments to be given to responders comprising their students.

iii) Collection, Organization, Analysis and Retrieval of Historic Data.

Certain of these embodiments of the present invention include methods for reporting previously completed DTGR and related information.

iv) Variety of Responders and Responder Groups.

Without limitation of the methods provided to evaluators for DTGR, certain embodiments of the present invention provide to evaluators methods for development, testing, grading or reporting in respect of all or any portions of, or a plurality of, entire classes or other groups of individual responders, including some or all of the following
(x) student bodies and student populations, members or employees of a single, or of a plurality of, groups, divisions, companies, entities, legal persons (including a trust, partnership or corporation) or other persons, departments, faculties, schools, universities, colleges and/or other institutions of learning or other institutions, and/or
(y) demographic groups or populations, whether defined by one more characteristics including age, location, activity, nationality, cultural connection, or otherwise,
   for purposes of monitoring, testing, evaluating, managing, auditing the capacities of such classes or groups, and/or other objectives in respect of the education, evaluation, admission, certification, approval, qualification, licensing, authorization improvement and/or governance of such classes or groups or the individuals therein. By way of illustration, one such embodiment provides methods for evaluators to perform DTGR in respect of legal state bar exams. Another such embodiment provides methods for evaluators to perform DTGR in respect of college admission tests.

v) Components in Electronic Form.

In the preferred embodiments of the present invention, the relevant portions of the evaluations and the responses are available in electronic form (such as a word processing document or HTML or XML documents such as a webpage.) However, the scope of the present invention includes embodiments in which the evaluations and responses may exist in printed or other forms, the relevant portions of which may be converted to electronic form, whether by optical scanning or otherwise, to create suitable electronic versions of those portions.

vi) Methods for Dynamic Modification.

Certain embodiments of the present invention provide methods for evaluators to develop and modify the grading procedure contained in those embodiments dynamically to optimize the quality of the evaluations and their effectiveness in testing the responders' capacities.

vii) Methods for Identify Verification

Certain embodiments of the present invention provide electronic verification methods to confirm the identities of responders.

### viii) Embodiment Including Methods for Grading

Certain embodiments of the present invention provide methods for persons, including individuals who act wholly or partially as teaching assistants or graders, to use the grading procedures of those or other embodiments to grade responses to instructions developed by other persons.

### ix) Embodiment Including Methods for Developing Instructions

Certain embodiments of the present invention provide methods for persons, including text book writers or publishers, to use the development methods of the present invention to develop instructions that may then be graded by other persons using the grading procedures of those or other embodiments.

### 2) Description of a Simple Embodiment and its Operation

A detailed description of a simple embodiment of the present invention will illustrate the general method and several of the other methods the present invention for some or all of development, testing, grading and reporting. The description that follows is intended solely to illustrate a single, particularly simple, practical and useful embodiment of the present invention, and not in any way to limit the present invention, its scope or application. The embodiments illustrated in FIGS. 1, 2A, 2B and 3 in the attached Drawings include this simple embodiment.

In this embodiment, evaluators are educational instructors that develop tests and assignments to be given to the responders who are their students. This simple embodiment is based on concepts, described in B]2) above, and provides an instructor methods to do some or all of the following:
1) combine flexibly and continuously in a single test or assignment questions associated with all common answer types, including but not limited to some or all of the following seven common question types: matching, multiple choice, true/false, fill in the blank, short answer, paragraph answer and essay,
2) identify flexibly and dynamically substantive grading attributes of answer quality,
   a. automatically through computer program methods,
   b. manually through instructor specification,
   c. dynamically through review of responses, or
   d. through any desired combination of the methods in a-c above
3) develop a grading function (and therefore, with the grading attributes, a grading procedure), as described below, based on these attributes,
4) apply the grading procedure to responses to develop preliminary grades,
5) improving the grading procedure dynamically, by revising the grading procedure based on a review of the preliminary response grades resulting from the initial grading procedure, in whole or in part, and
6) complete steps 1) through 5) above quickly and efficiently, on-line, off-line, or partially on-line and partially off-line, as the instructor prefers.

In this embodiment, concepts are expressed in synonym groups, which as described in D]1) and D]3)iii) above are groups of terms considered by the user to express the same concept, connected with the logical Boolean connector “OR”. Different synonym groups are connected with the logical Boolean connector “AND”. A response that refers to one or more terms from a synonym group results in appropriate grade credit, without duplication. If an instructor specifies different amounts of grade credit for different terms from a synonym group and a response includes references to more than one such term from that synonym group, by default the embodiment provides the highest grade credit among the terms from the synonym group that are referenced in the response. An instructor may provide a different rule than the default. This embodiment is illustrated through the development and/or grading of a “Take-Home Test”, discussed in the next section.

### i) Example

### The Take-Home Test

To describe this simple embodiment in greater detail, consider an evaluator who is an instructor and plans to develop, administer, grade and/or report a take-home test for her students, who are the responders described in B]1)[2] above. The test consists of a plurality of questions (the instructions described in B]1)[3] above) to which the students are to respond (the responses described in B] 1)[6] above) by providing answers. The embodiment may assist the instructor in identifying terms and concepts on which to base these questions, as shown in 12a and 12b of FIG. 2A in the Drawings and discussed in D]6)i) above. Alternatively, as shown in 12c of FIG. 2A, the instructor may develop the questions manually, and in either case may proceed on-line or offline, as shown in 13a, 13b and 13c of FIG. 2A.

In this embodiment, the test is developed by the instructor initially in a standard word processing format, and contains both text and one or more tables, described in greater detail below. In this embodiment, the instructor provides part or all of the grading attributes and the grading function to the computer-based grading procedure through a document referred to as an “AnswerKey”, also as described in greater detail below.

[1] Tables.

In this embodiment, the basic unit, or data structure, used for the instructor to provide her grading procedure and perhaps some or all of her questions, and for the students to provide their answers, is a “table”.

“Tables”, as their name suggests, are electronic word processing objects consisting of one or more cells organized into one or more rows and one or more columns. Tables may contain any number of rows and any number of columns, but there must be at least one of each, so that there is at least one cell in the table. The cells function in many ways like separate files that are linked by the ordering of the cells implied by the rows (the first cell is on the far left, the last cell is on the far right) and the columns (the first row is on top, the last row is on the bottom.) Indeed, tables are often implemented through the familiar and fundamental computer data structure known as a “Linked List”, in which each item in the list is linked to a subsequent item, or to “null” if the item is last, and to a preceding item, or to “null” if the item is first. (“Null” is a special constant value indicating the absence of assignment.)

Tables also represent the paradigm for the most basic database structure: each row represents a record, and each column represents a cell in that row that in turn represents a field in that record. Tables are venerable, well-understood and pervasive. Tables exist ubiquitously, for example, in all major word processing programs, including the cross-platform “Rich Text Format” (RTF), and on webpages in HTML and XML formats.

Tables are also particularly well-suited for containing, organizing and grading student answers to a variety of question types, including but not limited to the seven common types described above (namely matching, multiple choice, true/false, fill in the blank, short answer, paragraph answer and essay.) For example, the answer to an essay question may easily be provided in a table with a single row and a single column (a table with a single cell), suitable for a longer essay. In most word-processing programs, the single-cell expands or contracts to contain the answer, however long it may be. Tables appropriate for multiple choice and true false questions, by contrast, typically have several columns, including numbers for the questions, question text, including the text that poses the question or otherwise provides the instructions, perhaps other information related to the question, and space for the responders to provide their responses. Such tables with multiple columns may also be used for essay questions, if the user prefers. An example of a simple test with several question types, together with the answers, appears in the Exhibits—EXAMPLE OF ANSWERKEY—PHYSICS TEST below.

As a data structure, a table may be viewed as a Linked List of Linked Lists. The rows are the first of these Linked Lists; each row is linked to the next row (or null, in the case of the last row) and to the preceding row (or null, in the case of first row.) The cells (representing the columns) in each row are the second of these Linked Lists: each cell in a row is linked to the next cell (or null, in the case of the last cell) and to the previous cell (or null, in the case of the first cell.) Finally, if a file has several tables the tables may themselves be viewed as a Linked List: each table is linked to the next table (or null) and to the previous table (or null.) Thus, a file containing tables may be thought of as a Linked List of Linked Lists of Linked Lists.

Because tables are graphically friendly and familiar to humans, and may easily be interpreted as Linked Lists by machines, tables are well-suited for some or all of the following:
receiving, organizing and presenting questions in electronic or physical format,
receiving, organizing and parsing grading methodology specifications in a computer-based system, and
receiving, organizing, parsing, grading and reporting student answers to those questions in such a system.

A computer may easily iterate (loop) through any Linked List, starting with the first item in the list and proceeding to the next item sequentially until reaching the last item, processing, skipping or performing other actions in respect of particular items along the way if those items meet specified criteria.

Notwithstanding their ease and flexibility, tables are not essential to the present invention. For responders or instructors that lack access to any format that provides tables, or more generally where tables are otherwise unavailable or not preferred, other embodiments of the present invention provide methods for responders to provide their responses between specified delimiters, each delimiter consisting of a specified electronic code, such as a sequence of ASCII or Unicode characters. Indeed, from a machine perspective, tables themselves are in the first instance sequences of text separated by such specified delimiters.

[2] The Test File Tables.

In the embodiment discussed in this section F]2)i), the questions correspond to rows in one or more tables that are contained in a file (the “Test File”.) As indicated above, the format of the file may be that of any of the major word processing programs, including RTF, or in HTML or XML format. The embodiment provides methods to group questions that are related, whether because they are of similar type, address similar matters, or otherwise, into separate tables. The instructor may, however, specify any table organization for the Test File she prefers, from a table organization in which the row associated with each question appears in a separate table, at one extreme, to a table organization in which there is only one table for the entire test and each question corresponds to a different row in that table, at the other extreme. Whatever the table organization, for each question in the test, there always corresponds exactly one row in exactly one table. Each student is furnished with the Test File (on-line or off-line), and is instructed to provide his or her response (answer) to each question in the last column of the unique table row that corresponds to that question.

The tables in the Test File may have a single column or a plurality of columns, and if a table contains more than one column, the columns other than the last (which is reserved for the students' responses) may contain the question text, the question number, or other pertinent information. If the instructor chooses not to include the question text for some or all of the questions in the tables, that question text may appear in the Test File but outside the tables, with clear indication of the table rows to which the associated question(s) correspond. Alternatively, the instructor may provide the question text in a different document or elsewhere, and may use the Test File as an answer sheet furnished to students primarily as an organized framework in which they are to provide their answers.

In this embodiment, for each row with a plurality of columns, the system extracts the text, if any, from the cell in the next-to-last column of each row corresponding to a question, and treats that text, if any, as the text of that question. The instructor is not required to supply question text, or to provide question text in a table, but if she chooses to do so, the embodiment contains methods to extract the question text and to store it as the text of the question corresponding to the row in the next-to-last column of which it appears.

Alternatively, the instructor may a) provide the question text for the question corresponding to a particular row outside of any table, in which case the system will generally ignore it, or b) supply no question text. As shown in 13a, 13b and 13c of FIG. 2A, the instructor may create the test off-line or on-line. If the instructor chooses to create the test off-line, she can provide to her students the document she creates as the test itself. Alternatively, if she creates or finishes the test on-line as part of creating the AnswerKey, 13b of FIG. 2A, the embodiment provides methods to download a RTF file with all the questions collected into tables based on the question types, numbered and containing all the question text she properly supplied.

[3] The AnswerKey Tables.

In this embodiment, the instructor's specification of the grading procedure comprises an “AnswerKey”, which may be created off-line or on-line, as shown in 13a, 14b, 14c, 14d and 14e of FIG. 2A in the Drawings. An AnswerKey comprises, for each question
a) a specification of the question type (one of the seven types described above), and
b) a specification of other grading attributes, including:
   1. the terms structure, as described D]3)iii) above, comprising “AnswerTerms”,
   2. point counts, including point counts per term if the AnswerTerms contain multiple terms for that question, as described in greater detail below,
   3. characters and categories of characters (for example, punctuation) to ignore in reviewing the responses, and
   4. whether the response is to be tested for misspelling, and, if so, how great a misspelling to accept without treating the student answer as incorrect, and how much to reduce the grade for the extent of any misspelling.

The AnswerTerms comprise a specification of terms, and Boolean connectors connecting the terms. Each group of terms connected to each other with the Boolean connector “OR” may be thought of as a synonym group. The terms corresponding to a single synonym group may be thought of as representing the different ways a student might refer to the (single) concept associated with the synonym group.

Different synonym groups are in turn connected to each other with the Boolean connector “AND.” Thus in this embodiment the AnswerTerms for each question consist of one or more groups of one or more words or phrases. At least one member of each such group should be properly referenced in a fully correct (i.e. maximum grade point count) answer to that question.

The AnswerTerms and other AnswerKey information is contained a file, also called the “AnswerKey”, which contains the same number and type of tables as the Test File. The AnswerKey file may be in any of the formats described above for the test itself. To maximize flexibility of DTGR and minimize the distinction between on-line and off-line test development, this embodiment provides methods for the instructor to use the Test File itself as the AnswerKey, by including the AnswerTerms and other AnswerKey information for each question in the last cell of the unique table row in the Test File corresponding to that question.

More specifically, the Test File provided to the students has the last cell blank in each row corresponding to a question. To finish the AnswerKey, the instructor merely adds the AnswerKey information to each such last cell. The embodiment then provides upload methods for the instructor to upload the resulting AnswerKey file to the system, which then, as shown in 14e of FIG. 2A, parses the tables in the file, extracts the AnswerTerms and other AnswerKey information and stores them in a database. An example of an AnswerKey with associated AnswerTerms and question text is shown in the Exhibits—EXAMPLE OF ANSWERKEY—PHYSICS TEST below. The corresponding Test File consists of the AnswerKey with the final column in each question corresponding to a question blank, in which the student is to provide his or her answer. A hypothetical completed student answer appears in the Exhibits—Error! Reference source not found. below.

Of course, as indicated previously, the AnswerKey may be created, revised and/or finished on-line, as an alternative to off-line development. In on-line AnswerKey development and completion, the AnswerKey information is entered directly into the relevant database through a Webpage. As discussed below, this embodiment also provides download methods for the user to download the AnswerKey to a RTF document, with tables, on the user's local machine. Thus, the user may shift the development of the AnswerKey between the on-line and off-line environments, seamlessly, as shown in 15a, 15b of FIG. 2A.

Once the AnswerKey has been finished and finalized, this embodiment provides methods for the instructor to upload student responses if the students have not uploaded their responses themselves, 16a and 16b of FIG. 2A, each in the form of a Test File with answers provided in the final columns of each table. As shown in 17a of FIG. 2A, the embodiment then applies the grading procedure to grade the uploaded student responses, as follows. The embodiment grades a student response to a question by extracting from the associated table row's last cell the text of the student answer, stoplist filtering that text based on a specified stoplist the instructor may edit or eliminate, and matching that student answer text against the AnswerTerms in manner that reflects the question type and Boolean connectors selected by the instructor. If the question type is true/false, exact match or fill-in-the-blanks, the embodiment deletes from the student answer text any characters or categories of characters specified by the instructor in 3 above, compares the student answer text against the associated (single) AnswerTerm, deleting from the student answer text the AnswerTerm found, and treats the student answer as correct only if both a) the AnswerTerm is matched, and b) no characters remain after deleting the AnswerTerm. The latter requirement prevents a student from providing multiple answers rather than accurately identifying the correct one. If the student answer is correct, the point count specified by the instructor is awarded to the student for that question, subject to any reduction specified by the instructor for misspelling to an acceptable extent. (Misspelling to a greater extent than the maximum specified by the instructor results in the student answer being treated as incorrect.)

If the question type is multiple choice, the grading procedure follows a similar procedure except that multiple AnswerTerms are permitted. The meaning of the term “multiple choice” as used in the present invention is somewhat different than the conventional meaning of that term. In its conventional meaning, the answer to a multiple choice question is the selection of exactly one of a number of possible answers, which would be of the “exact match” question type in the present invention. By contrast, in the present invention the “multiple choice” question type requires a selection of exactly the right subset of the possible answers, which may include more than one of them. The term “Exact List” was used for this question type in section B]2) above.

In the event of multiple AnswerTerms for a multiple choice question, the terms are deleted from the student answer text as they are matched, and the student answer is treated as correct only if both a) all AnswerTerms are matched, and b) no characters remain after deleting all the AnswerTerms. A correct student answer is awarded the specified grade point count, subject to any misspelling reduction.

If the question type is short answer, paragraph answer or essay type, the student answer text is matched sequentially against each synonym group. For each synonym group, the student answer text is matched against each term in the synonym group. If a term in a synonym group is found, the grade point count for that synonym group is awarded to the student response for that question for that synonym group, and the grading procedure continues to the next synonym group. If the instructor has specified different point counts for different terms in a synonym group, the grading procedure tests for the different terms in the synonym group in decreasing order of the associated grade point counts, ensuring that the student gets the maximum point count among all the terms in that synonym group that are appropriately referenced in the student's answer.

The effect of the grading procedure applied to short answer, paragraph answer and essay type questions is therefore as follows. The total grade point count for a student answer equals the arithmetic sum of the grade point counts associated with each synonym group, at least one term in which is referenced appropriately in the student answer. In this embodiment, a term is appropriately referenced if that term occurs in the student answer text. Thus, in this simple embodiment, the grading function as applied to a synonym group is a simple Boolean function; either the text of at least one term from the synonym group appears, or it doesn't. The latter case results in zero point count. The former case generally results in the full point count for the synonym group, but subject to possible different point counts for different terms and/or misspelling reductions.

More conceptually, the grading function treats the student answer as consistent with the AnswerKey, and thus qualifying for grade point counts, to the extent that the student answer text references appropriately at least one AnswerTerm associated with each concept in the AnswerKey. One student answer receives a higher grade than another student answer to the extent that under the grading procedure the first student answer displays greater consistency with the AnswerKey than the second student answer. Compare D]3)ii) above and particularly D]3)ii)[2] and D]3)ii)[3] above.

Other embodiments provide the instructor methods to specify different grading procedures and AnswerKeys based on different measures of consistency, including, without limitation, the cosine of the angle between the AnswerKey and the student answer, viewing each as a vector in a Euclidean space, as described in D]3)ii)[2] above. See, for example, Rijsbergen, chapters 3, 5; Dumais, S. et al, Using Latent Semantic Analysis To Improve Access To Textual Information, each cited in C]2)vi)[1] above. These other embodiments provide instructors methods to specify grading procedures based on several different measures of consistency between student answers and AnswerKeys, including “mutual information” and “chi-squared” measures, as indicated above. If the instructor has selected a method to test for misspelling certain of these embodiments, a student answer is parsed into separate terms and the distance between each student answer term and each AnswerTerm computed to determine whether the distance is within the maximum specified by the instructor and, if so, how much the grade point count should be reduced to reflect any misspelling. Compare D]6)ii) above.

[4] Analysis and Reports

This simple embodiment provides the instructor methods to review the results of the application of the grading procedure to the student responses, including the grades, and methods to revise the AnswerKey to improve the effectiveness, including the accuracy, of those grades in assessing the quality of the student responses. More specifically, as shown in 17a of FIG. 2A, the embodiment provides the instructor methods to view the student grades displayed either by question or by student. The question display lists for the each selected question each student's response and the grade for that response, highlighting in the text of the student response the AnswerTerms matched, together with certain relevant AnswerKey information for the question. An example of one such question display of student grades appears in Attachment 2. The student display lists for the selected student each of the student's answers and grades, highlighting in the student's answers the AnswerTerms found, together with certain relevant AnswerKey information. An example of one such student display appears in Attachment 3. As shown in 17b and 18 of FIG. 2A, this embodiment provides the instructor methods to revise the AnswerKey after review of how the AnswerKey performed in practice, by adding new AnswerTerms the instructor believes should have been included in the grading procedure, modifying or deleting existing AnswerTerms, and/or modifying other AnswerKey information, such as the point counts, the characters to ignore, the Boolean connectors or the question type. This embodiment also provides the instructor methods to revise the final grades for any student's answer to any question manually, without modifying the AnswerKey, if the instructor feels the grade provided by the AnswerKey should be adjusted but prefers not to revise the AnswerKey.

As shown in 18 of FIG. 2A, once the instructor has finished revising the AnswerKey and the student grades, the embodiment provides a several reports and analysis, displayed either by student or by question, and in summary or detailed form. An example of a report displayed by student appears in Attachment 4. These reports provide some or all of the following: all student grades, both as graded by the system and, if relevant, as manually revised, for each student, by question and in aggregate for the test, and statistical analysis such as average grades (by question and in aggregate for the test) and histogram and other grading curve information. The embodiment provides the instructor methods to download the reports to her local machine in one or more standard formats, including as spreadsheets and text.

### ii) Other Applications of Simple Embodiment

The methods of the simple embodiment described in the context of a take-home test in i) above also comprise methods for instructors and other users to do some or all of the following: developing, administering and/or grading, and/or reporting the results of grading, for any task or evaluation, not confined to take-home tests. Such task or evaluation may include some or all of the following: homework assignments, other assignments, quizzes, tests, exams, problem sets, essays, exercises, projects, mid-terms and other tasks and evaluations.

As described with respect to the take-home test, an evaluation should have a single row in a unique table for each question or other task that the evaluation includes. The AnswerKey for such an evaluation should also have a single row in a unique table for each such question or other task. The students should provide their answer to each question, or their response to each task, in the last cell of the table row in the evaluation corresponding to that question or task. The instructor should provide her AnswerTerms and other relevant AnswerKey information for each question or task in the last cell of the table row in the AnswerKey corresponding to that question or task. The methods for developing, testing, grading and/or reporting are otherwise generally as described above for the take-home test.

G] Operation of Certain Embodiments and List of Reference Numerals for Flowchart Process Drawings

A brief description of the several views of the attached Drawings follows. The flowchart in FIG. 1 contains an overview of certain embodiments of the invention. The flowchart in FIG. 2A and FIG. 2B illustrates the process of the DTGR methods provided by certain of these embodiments in greater detail. The flowchart in FIG. 3 contains a broad overview of the plagiarism testing methods provided by certain embodiments of the present invention. A table of Reference Numerals follows, together with a summary of the operation of those embodiments.

| Numeral | FIG. 1 |
|---|---|
| 1 | Create evaluations, including tests, |
| | exams, quizzes and/or assignments. |
| 2 | Create AnswerKey or other Grading |
| | Procedure to grade students', or other |
| | responders', responses to evaluations |
| 3 | Obtain student responses and upload, |
| | or have students upload directly to the |
| | system. |
| 4 | Check for plagiarism, if desired |
| 5 | Grade student responses using Grading |
| | Procedure |
| 6 | Analyze resulting of grading, and |
| | report such grades and analysis, storing |
| | and transferring as required |
| 7 | Compile such analysis and reports and |
| | compare with other analysis and |
| | reports |

| NUMERAL | FIG. 2A and FIG. 2B |
|---|---|
| 11a | The user enters his/her username and password. |
| 11b | On a “My Accounts” page, the user either creates a new course or selects an existing |
| | course, in which to create tests, exams, assignments or other evaluations. |
| 12a, 12b, 12c | In certain embodiments, the user chooses (12a) either to: |
| | (12b) provide materials to those embodiments' concepts development |
| | methods, following which the user reviews the resulting list of promising |
| | concepts and selects the concepts s/he prefers, |
| | (12c) develop concepts manually, on-line or off-line, or |
| | develop concepts through a combination of on-line and off-line methods. |
| | In other embodiments, the user must develop the concepts manually, on-line or off- |
| | line. |
| | In certain embodiments, the concepts comprise synonym groups. |
| 13a, 13b, 13c | The user chooses (13a) either to: |
| | (13b) develop a test, exam, assignment or other evaluation on-line, using on- |
| | line evaluation development methods, beginning with the “Edit AnswerKey” |
| | page (an example of which appears in Attachment 1), and adding questions |
| | through the methods on that page, or |
| | (13c) develop the evaluation off-line, in any in word processing program or |
| | other editor that supports tables, as shown in the Exhibits -- EXAMPLE OF |
| | ANSWERKEY - PHYSICS TEST below. There must be exactly one table |
| | row for each question. Certain embodiments provide methods to download a |
| | template as a guide to evaluation development, if the user chooses. |
| 14a through 14e | User chooses (14a) either to create the AnswerKey on-line or off-line. |
| | (14b) In on-line AnswerKey development, the user may base the AnswerKey |
| | on an evaluation, first uploading the evaluation, if the evaluation were created |
| | or finished off-line. Once the evaluation is uploaded, the system parses it to a |
| | database. |
| | (14c) The user then navigates to the “Edit AnswerKey” page, (compare |
| | Attachment 1), which displays as an AnswerKey the parsed evaluation |
| | that the user uploaded, if any. On this page, s/he can add the |
| | AnswerTerms to the AnswerKey, along with Boolean connectors, point |
| | counts, question type and other grading attributes. |
| | Alternatively, the user may develop the AnswerKey on-line independent |
| | of the evaluation, by using the “Edit AnswerKey” page, adding the same |
| | number of questions as in the evaluation, and adding the AnswerTerms to |
| | those questions. |
| | (14d) In off-line AnswerKey development, the user may base the AnswerKey |
| | on the evaluation, first downloading the evaluation, if it was created or |
| | finished on-line. |
| | Once the evaluation is downloaded, the user opens it in any in word |
| | processing program or other editor that supports tables. The user then |
| | adds the AnswerTerms and other relevant AnswerKey information for |
| | each question in the final column of the (unique) table row corresponding |
| | to that question. |
| | Alternatively, the user may develop the AnswerKey off-line independent |
| | of the evaluation, by creating one or more tables, and rows in those |
| | tables, that generally correspond to the tables and rows in the evaluation. |
| | (14e) Having completed the AnswerKey off-line, the user uploads it to |
| | the system, which parses it and writes it to a database. . |
| 15a, 15b | If not already open, the user opens the “Edit AnswerKey” page, which displays the |
| | parsed AnswerKey that the user created and/or uploaded. The user makes any edits and |
| | other revisions, and finalizes the AnswerKey. The system is now ready to grade |
| | Student Answers. |
| 16a, 16b | The user uploads student answers, if they have not previously been uploaded, and |
| | reviews them on-line if needed. If the user wishes to test the AnswerKey as part of its |
| | development, s/he may upload only a portion of the student answers. |
| 17a, 17b | At the user's direction, the system grades the student answers and provides detailed |
| | reports and analysis of the grades and the student answers for the user's review. In |
| | certain embodiments, the system provides a report with all the AnswerTerms found in |
| | each student answer highlighted, to facilitate the user's review. |
| | If the user is not satisfied with the grading, the user may edit the AnswerKey and grade |
| | the student answers again, repeating this process until the user is satisfied with the |
| | AnswerKey and the resulting grading. |
| 18 | The user makes any final manual overrides to the system grades, and finalizes the |
| | grades, together with the associated reports and analysis, which are stored by the |
| | system in a database. In certain embodiments, the finalized grades, reports and analysis |
| | are transmitted to the sponsoring educational institution, if any, or to other persons for |
| | their review and storage. |
| 19 | The process ends. |

| REFERENCE | |
|---|---|
| NUMERAL | FIG. 3 |
| 21a | The user selects, or omits, a “stoplist” of common words to deleted from responses and |
| | ignore as irrelevant to the plagiarism test. |
| 21b | The user selects a probability model for the system to use to model the frequency |
| | with which the terms in the responses' features structure occur. |
| | The user specifies the threshold probability for plagiarism, below which plagiarism |
| | is suggested |
| 22a, 22b | (22a) The system determines the response term frequencies from the responses, |
| | and estimate the parameters of model from those term frequencies. |
| | (22b) The system determines the distances between each pair of the responses, |
| | based on the responses' feature structures and standard distance measures. |
| 23a, 23b, 23c, | (23a, 23b) The system selects the two responses the short distance apart, and the |
| 24a | probability, based on the model estimated earlier, of a distance that small occurring |
| | randomly, using standard statistical methodology. |
| | (23c, 24a) If this probability is less than the specified threshold, the system |
| | displays to the user the two responses, which the user may inspect for confirmation of |
| | plagiarism. |
| 24b, 24c | If the user concludes there may have been plagiarism, the associated responders are |
| | examined for a definitive determination. |
| 25, 26 | The user determines whether to cause the system to analyze the remaining two |
| | responses that are the next closest. When the user is satisfied with the responses that |
| | have been tested for plagiarism, the user instructs the system to quit and the process |
| | ends. |

H] The Claims

See Claims in separate document.

I] Exhibits

1) Example of AnswerKey—Physics Test

Course Name: Survey of Physics

Assignment Name: Take-Home Mid-Term

Max Score: 21.00

If you are a first time user, or otherwise want to know more about this Assignment Summary, please see “About This Assignment Summary” at the end.

Short Answer

| Question | | | | |
|---|---|---|---|---|
| No | Section | Marks | Question | Answer Terms |
| 1 | 1.1 | 7.00 | Describe the principal developments in | Einstein AND relativity AND |
| | | | theoretical physics at the beginning of | quantum mechanics OR wave |
| | | | the 20^{th} Century, with the physicists | mechanics AND Schroedinger AND |
| | | | who discovered them, and comment | Heisenberg AND uncertainty |
| | | | briefly on their significance. | principle AND Brownian motion |

Exact Match/Fill in the Blanks

| Question | | | | |
|---|---|---|---|---|
| No | Section | Marks | Question | Answer Terms |
| 2 | 2.1 | 2.00 | As a result of early 20th century research on | 4 |
| | | | the nature of light, we now understand that | |
| | | | light may be viewed as | |
| | | | 1) a wave | |
| | | | 2) a particle | |
| | | | 3) neither a wave nor a particle | |
| | | | 4) both a wave and a particle | |
| 3 | 2.2 | 2.00 | Measuring the speed of light is an example of | c OR experimental |
| | | | which kinds of physics? | empirical OR experimental |
| | | | a) experimental | and empirical OR both |
| | | | b) empirical | experimental empirical |
| | | | c) both experimental and empirical | |
| | | | d) theoretical | |
| | | | e) all of the above | |

Short/Paragraph Answer

| Question | | | | |
|---|---|---|---|---|
| No | Section | Marks | Question | Answer Terms |
| 4 | 3.1 | 10.00 | In the 10th century, physicists believed | Michelson AND Morley AND |
| | | | there was an absolute frame a reference, | Michaelson-Morely experiment |
| | | | sometimes loosely associated with an | AND Einstein AND speed of light |
| | | | “aether.” This belief is now considered | OR light speed AND constant |
| | | | in error. Comment on the physics that | AND relativity AND special |
| | | | is considered to have rejected this | relativity OR special theory of |
| | | | belief, including the physicists | relativity AND 1887 AND faster |
| | | | responsible, as well as some of the | than light OR slower than light |
| | | | more surprising consequences of the | OR limit on the speed OR bound |
| | | | rejection. | on the speed OR limit on the |
| | | | | velocity OR bound on the velocity |

About This Assignment Summary: This summary (“Summary”) of the assignment: Take-Home Mid-Term is intended to summarize the assignment's features most relevant to grading the assignment. As you can see, this Summary consists of 3 tables, one for each group of questions, grouping questions by “question type”. Each table has one row for each question in the associated question group, and five columns. The columns are as follows:

Column 1: Column 1 contains the absolute number of the question, numbering all questions consecutively from first to last.

Column 2: Column 2 contains the relative number of the question, expressed in decimal notation in the form:

(question group number).(number of the question in its question group)

Column 3: Column 3 contains the points for each answer term, and the maximum number of points, expressed in decimal notation in the form:

(point count for each answer term).(maximum points for the question)

Column 4: Column 4 contains the text of the question, if (and only if) you included that question in the AnswerKey.

Column 5: Column 5 contains the Answer Terms for the question, along with the logical connectors between those terms and the Ignore List, if any.

2) Example of Student Answer—Physics

| | Question | Answer |
|---|---|---|
| 1 | Describe the principal developments in | Einstein developed the theory of relativity and laid |
| | theoretical physics at the beginning of the | some of the ground work for quantum mechanics, |
| | 20^{th} Century, with the physicists who | as well as using Brownian motion to demonstrate |
| | discovered them, and comment briefly on | the existence of molecules and atoms.. |
| | their significance. | Schroedinger developed the basic equations for |
| | | quantum mechanics, also known as wave |
| | | mechanics. Heisenberg developed the uncertainty |
| | | principle. |
| 2 | As a result of early 20^{th} century research | 4 |
| | on the nature of light, we now understand | |
| | that light may be viewed as | |
| | 1) a wave | |
| | 2) a particle | |
| | 3) neither a wave nor a particle | |
| | 4) both a wave and a particle | |
| 3 | Measuring the speed of light is an | c |
| | example of which kinds of physics? | |
| | a) experimental | |
| | b) empirical | |
| | c) theoretical | |
| 4 | In the 10^{th} century, physicists believed | The Michelson Morley experiment was performed |
| | there was an absolute frame a reference, | in 1887 and was the first strong evidence against |
| | sometimes loosely associated with an | the theory of a aether. The results of this |
| | “aether.” This belief is now considered in | experiment suggested strongly there are no |
| | error. Comment on the physics that is | absolute reference frames, but rather that physical |
| | considered to have rejected this belief, | measurements must be taken relative to a specified |
| | including the physicists responsible, as | reference frame. This led Einstein to develop his |
| | well as some of the more surprising | special theory of relativity, according to which the |
| | consequences of the rejection. | speed of light is constant from all reference |
| | | frames, and is an upper bound on the speed of any |
| | | physical object. |

J] Code Listing

The code listing for this patent application consists of three files, each in ASCII (text) format, with the following characteristics. This code listing has been submitted both on CD and electronically.

| | Machine | | | |
|---|---|---|---|---|
| File Name | Format | Operating System | Size (Bytes) | Creation Date |
| DL_Distance.txt | PC | Windows XP | 5,000 | May 6, 2009 |
| MinDistSubstring.txt | PC | Windows XP | 3,000 | May 6, 2009 |
| GPEvaluation.txt | PC | Java Virtual Machine | 16,000 | Apr. 14, 2009 |

The computer programs represented by each of the first two file may be executed in a Windows XP environment running Windows Script Host by saving the file with a “.wsf” extension (instead of “.txt.”) and running it. The files incorporate “Windows Script”, VBScript and Jscript.

The third file, GPEvaluation.txt, is written in Java and is platform-independent, and illustrates the “grading” method of one embodiment of the current invention.

K] Attachments:

See separate attachments pages.

One skilled in the art will appreciate that the present invention can be practiced by other than the described embodiments, which are presented for purposes of illustration and not of limitation. Those skilled in the art will have no difficulty devising obvious variations and enhancements of the invention, all of which are intended to fall within the scope of the claims which follow. References below to a user include references to some or all other individuals for or on behalf of whom, or together with whom, the user is acting.

What is claimed:

1. An automated system and methods providing means for one or more human users, acting in coordination with each other if there is more than one user, to grade, assess or otherwise evaluate the responses of one or more individual responders to instructions to perform tasks provided to said responders by or on behalf of some or all of said human users, said system and methods comprising
(a) providing one or more general computers in which the system has been installed, which may be the users' computers or may be connected to the users' computer through a network, or otherwise,
(b) providing a first input means which the users can use to input or upload responses of said responders to the system, whether by email, file transfer or otherwise,
(c) providing an answer key based on which users may cause the system to grade or otherwise evaluate said responses automatically,
(d) providing answer key development means which the users can use, online within the system or offline outside the system, at the users' choice, to develop, create, modify, revise, store or retrieve said answer key, the answer key comprising a method expressed in an electronic document substantially in natural human language that may be read and understood by said human users, for specifying to the system the basis for grading or otherwise evaluating said responses,
(e) providing a second input means which the uses can use to input or upload to the system said answer key, if said answer key were developed offline outside the system, whereby the answer key becomes online within the system,
(f) providing a display, review and modification means which the users can use to display, review, modify, revise, edit, expand, store or retrieve said answer key, said answer key being online within the system, whether through development online within the system or through said second input means,
(g) providing a first output means which the users can use to output or download said answer key from the system to a general computer, whereby the users may display, review, modify, revise, edit, expand, store or retrieve said answer key outside the system, said answer key being offline outside the system after such output or download, and whereby the users may use said second input means to input or upload a modified, revised, edited or expanded answer key back to the system, replacing the original answer key or comprising a new, additional answer key, as the users choose,
(h) providing parsing means which the users can use to cause the system to extract from the answer key the information that specifies the grading or evaluation methodology for grading or otherwise evaluating said responses,
(i) providing a grading means which the users can use to cause the system to grade or otherwise evaluate said responses automatically based on the answer key the system has parsed,
(j) providing reporting means which the users can use to cause the system to display one or more reports for the users to review, said reports comprising the results of said grading or evaluation, including numerical or other grades or evaluations and including means for identifying the specific basis of the application of the answer key to each of said responses or portion of said responses, whereby the users may use
(A) said display, review and modification means to review, modify, revise, edit or expand the answer key to improve the quality of the grading or other evaluation,
(B) said parsing means to parse said modified answer key,
(C) said grading means to grade or otherwise evaluate said responses anew based on said modified answer key, and
(D) said reporting means to display reports of said grading or other evaluation based on said modified answer key,
in each case as many times as the users choose, whereby the users may optimize the results of said grading or other evaluation, and
(k) providing a second output means which said human users may use to output or download said reports from the system to a general computer, whereby the users may display, review, store or retrieve such reports outside the system, or transfer or distribute them to other individuals, or to groups, companies, institutions or governments.

2. The system and methods of claim [1], wherein
(a) said responders comprise one or more of the following:
(A) full-time, part-time or continuing education students,
(B) individuals engaged in self-teaching, self-learning or self-instruction, or
(C) a group identified based on the responders' age, location, activity, nationality, cultural connection, educational level, educational ambition, profession, professional ambition or presence in a geographic region or membership in other geographic or demographic group, or other characteristics,
(b) said users comprise one or more of the following:
(A) educational or other instructors, teaching assistants, professors, sessional instructors, grading assistants, graders, graduate students or grading assistants,
(B) admission, approval, authorization, certification, examination, licensing, permission, qualification or testing bodies, institutions, organizations or authorities, or
(C) agents, or persons otherwise acting on behalf, of any thereof, and
(c) said instructions to perform tasks comprise one or more of the following
(A) one or more problems to solve,
(B) one or more exercises or projects to complete, and
(C) one or more questions to answer such as
(i) true/false questions,
(ii) multiple choice questions,
(iii) matching questions comprising a plurality of questions together with the correct answers to those questions in an unordered list, from which list the correct answer for each question must be selected by the responder and matched to the related question,
(iv) fill in the blank questions comprising of one or more statements containing one or more blanks or empty spaces that the individual responder must fill in,
(v) short answer questions comprising a question the answer to which is to be provided in the form of one or a small number of sentences,
(vi) paragraph answer questions the answer to which is to be provided in the form of one or a small number of paragraphs, and
(vii) essay questions the answer to which is to be provided in the form of an essay comprising a series of paragraphs on one topic or a plurality of related topics, and
(d) some or all of the group comprising said responses, said answer key and said reports are provided in electronic form, such as in a text file, a hypertext markup file or a word processing file, including, without limitation, a document in rich text format or a document in one of the formats used by the word processing programs offered by established software vendors.

3. The system and methods of claim [1], wherein said instructions to perform tasks comprise one or more of the following
(a) a final exam, a mid-term exam or other examination, a test, a pop quiz or other quiz, a term project, a special project or other project, a special exercise, a class exercise or other exercise, a homework assignment, a group assignment or other assignment, a final paper or other paper, a thesis, or
(b) an admission, approval, authorization, certification, aptitude, intelligence, advance placement, other placement, licensing, permission or qualifying test or examination.

4. The system and methods of claim [1], further including instruction development means for developing said instructions to be given to the responders, online on a network such as the Internet or a local intranet, or offline on a local machine, said means comprising an electronic document template, such as a html document, rich text format document or word processing document containing a table, in which the user may input descriptions of said tasks to be performed by the responders, including tasks to be performed by providing written responses, such as answering one or more questions, completing one or more exercises or projects, solving one or more problems, and/or writing one more or essays.

5. The system and methods of claim [1], further including some or all of the group of computer methods comprising
(a) computer methods providing means to review and analyze the results of said grading or evaluation, including means to review the evaluated responses with the basis for the evaluation highlighted or otherwise displayed or isolated for review, organized and displayed on one or more bases specified by the users, including without limitation organized by collecting together all the responses to each single question or task, whereby the users may easily review and compare all the different responses to each such question or task,
(b) computer methods providing means to revise the grading or other evaluation procedure based on such review and analysis, whereby the users may improve the accuracy and quality of such grading or evaluation, and
(c) computer methods providing means to develop reports of the evaluation and of the analysis of the evaluation, including methods to download, upload, transfer, transmit, distribute, store, retrieve, extract, compare and analyze those reports, whereby said reports may be shared with other individuals, groups, companies institutions or governments that seek information on the performance of the responders, whereby users of the reports and analysis may evaluate the quality of teaching or other education provided to said responders.

6. The system and methods of claim [1], wherein
(a) said responses and said answer key are provided in electronic form, such as in a text file, a hypertext markup file or a word processing file,
(b) said answer key comprises two lists and certain rules,
(A) the first list comprising a list of specified terms for each task responders are instructed to perform, such terms
(i) being associated with correct responses or otherwise associated with responses that should received a better grade, and
(ii) comprising words, phrases, single characters or multiple character sequences, such characters including letters, numerals, punctuation, blanks, spaces, special formatting characters, other special characters and other characters,
(B) the second list comprising a list of separate point counts for each of such terms on said first list of terms, said point counts comprising one or two numbers for each of said terms, said first numbers, being typically positive, specifying the numeric points to be awarded to such response if the response appropriately references those terms, as further described below, and said second numbers, if present being typically negative, specifying the numeric points to be awarded to such response if the response does not appropriately reference those terms,
(C) the rules, which may include Boolean logic rules or decision tree rules, in respect of the terms on such first list of terms, providing the users means to do some or all of
(i) connecting some or all of the terms on such first list associated with a specific task into one or more groups of terms, such as synonyms, if so specified by the user,
(ii) determining the extent to which such terms, or connected groups of such terms, should be treated as appropriately referenced, or in the alternative not appropriately referenced, in a response, such determination based on whether or not such terms or groups of terms satisfy such rules in respect of such response, for example by determining whether such terms or groups are
(I) present as contiguous text in the response text, or otherwise present in the response,
(II) present in the response in a specified location, order, format or manner, as provided in said rules, or
(III) present in the response in a manner or to an extent that otherwise satisfies such rules, including rules
(1) requiring that certain such terms or groups be present in the alternative in the responses text, such as where such terms or groups are synonyms for each other, or
(2) requiring that certain other such terms or groups are present in the conjunctive, such as where such terms or groups are necessary components of a unitary, whole concept,
(c) said grading means provides computer methods to develop numeric point count grades for some or all of said responses based on said answer key, such methods comprising
(A) computer search methods providing the users search means to perform automatic electronic searches through all the characters, including letters, numerals, punctuation, blanks, spaces, special formatting characters and other special characters, in respect of each responder's response to each task specified in said instructions,
(B) computer point count evaluation methods based on such searches providing grading means to determine a separate point count, or grade, for each responder's response to each task, comprising, for such response to a such task,
(i) first, computer means to determine for such response, a separate point count for each term on such first list of terms in respect of such task, or group of such terms, based on the separate point counts for such terms for such task provided on such second list, by awarding, for each such term or group of terms,
(I) the first associated numeric point count, if and to the extent such term or group of terms is determined to be appropriately referenced in such response, based on the provided rules, and
(II) the second associated numeric point count, if present, if and to the extent such term or group of terms is determined not to be appropriately referenced in such response, based on the provided rules,
(ii) second by combining, through simple addition or other combination method provided by such rules, such separate numeric point counts for each such term or group on such first list in respect of such task, to determine an overall numeric point count, or grade, for such responder's response to such task, and
(iii) third by combining, through simple addition or other combination method provided by such rules, the numeric point counts for each responder's response to each task, to determine an overall numeric point count, or grade, for that responder,
(d) computer methods providing display and reviewing means for the user
(A) to display and review such separate numeric point counts for each such responder's response to each task, for separate terms or groups of terms, or such overall numeric point counts for each responder, whereby the user may revise such first and second lists, and such rules, to improve the quality of the grading or other evaluation of the responses,
(B) to redetermine, based on such revised first and second lists and such revised rules, such numeric point counts for each response, or for a plurality of responders' responses, and
(C) optionally, at the user's choice, to adjust manually the separate and/or overall numeric point counts as desired for separate terms, groups of terms, or overall, for one or more responses to one or more tasks, whereby to selectively override manually and improve the quality of the final numeric point count grades for one or more responses or for all the responses.

7. The system and methods of claim [6] wherein such answer key also includes a second list of terms and the rules contained in the answer key provide that, at the outset of grading responses, each term in such second list is first deleted from each response and not consider further in grading, whereby the grading method will not be mislead by the presence of such terms on the second list,

8. The system and methods of claim [6] wherein under such rules provided in said answer key, a term in such first list associated with a task, or group of such terms, is determined to be appropriately referenced, or in the alternative not appropriately referenced, in an individual responder's response to a task, based on whether that term, or one or more terms in such group, viewed as a string, exactly matches, or in the alternative does not exactly match, a substring in such response text, wherein exact matching is determined on the basis of any of the following group of bases for determining exact matching
(a) exact matching is determined with regard to such term's formatting but without regard to its capitalization,
(b) exact matching is determined without regard to either such term's formatting or its capitalization,
(c) exact matching is determined with regard to both such term's formatting and its capitalization, or
(d) exact matching is determined with regard to such term's capitalization but without regard to its formatting.

9. The system and methods of claim [6],
(a) wherein such rules provided in said answer key provide, to identify misspelling or for other related or unrelated objectives, that a term in such first list associated with a task, or group of such terms, is determined to be appropriately referenced, or in the alternative not appropriately referenced, in an individual responder's response to a task, based on whether that term, or one or more terms in such group, viewed as a string, approximately matches, or in the alternative does not approximately match, a substring in such response text, wherein approximate matching is determined based on whether a substring in such response text is a distance from such term that does not exceed a maximum distance specified for such term, and is further determined on the basis of any of the following group of bases for determining approximately matching
(A) approximately matching determined with regard to such term's formatting but without regard to its capitalization,
(B) approximately matching determined without regard to either such term's formatting or its capitalization,
(C) approximately matching determined with regard to both such term's formatting and its capitalization, or
(D) approximately matching determined with regard to such term's capitalization but without regard to its formatting,
(b) further including computer methods providing
(A) means for the user to specify an additional numerical list in said answer key, such additional numerical list comprising, for each term in the first list, the maximum distance specified for that term, and
(B) means for the user to specify a methodology to determine the distance between each term in the first list in the answer key and a substring of such response text, by selecting from a group of methodologies for determining distance, comprising
(i) the edit distance,
(ii) the overlap distance,
(iii) the order distance,
(iv) the overlap and order distance, or
(v) another distance measure,
(C) means for the user to search the response text for substrings, with or without stoplist or other filtering, and to determine the distance from each such substring to each term associated with the task corresponding to that response, and to determine whether in each case that distance exceeds the specified maximum distance, and
(D) means for the user to specify in said answer key, for each task and for each term on the first list in respect of such task and each integral positive distance that is not greater than the specified maximum distance for such task, a point count reduction for such distance by which the numeric point count under the second list associated with that term will be reduced in the event a substring in the response text approximately matches, but does not exactly match, that term, such reduction to reflect the distance from that substring to that term, thereby reducing the numeric point count for that term to reflect the misspelling of such term or otherwise to reflect the extent to which that term was not matched exactly, and

10. The system and methods of claim [1], further including computer methods for
(a) analysis means for analyzing statistically or otherwise some or all of the following
(A) the numeric point count grades or other grades for one or more responses to one or more tasks,
(B) such grades for groups of tasks, or for all tasks, for some or all responders, and
(C) said answer key, including the grading means, that provided those such grades,
(b) reporting such analyses and such grades, including any aggregate numeric points count grades, and
(c) processing such reports or such analysis, including assessing, formatting, transferring, transmitting, distributing, monitoring, compiling, organizing, publishing, comparing, combining, displaying, compressing, recording, reporting, revising, storing, retrieving, reviewing, extracting or displaying such reports and such analysis, and comparing such reports or such analyses with other reports or analyses of responses of different responders, whereby skills of responders and educators may be evaluated and compared.

11. The system and methods of claim [1], further including computer methods providing users means to identify tasks to instruct the individual responders to perform to evaluate their familiarity with and understanding of specified subject matter, based on materials, or a plurality of materials, provided by the users in, or convertible into, electronic form, such computer methods including any one or more of the following
(a) materials separated into two or more parts, the first part of which materials comprises content specifically related to such subject matter on which responders are to be evaluated and the second part, or parts, of which materials comprises
(A) content that is not specifically related to such subject matter, including without limitation content that may be related to different subject matter, or
(B) a general corpus of written english, such as the brown university standard corpus of present-day american english,
(b) computer methods for a user to provide such materials, including some or all of upload, file transfer and email methods,
(c) computer search methods for a user to search such materials for terms, including words, phrases and single character or multiple character sequences, such characters including letters, numerals, punctuation, blanks, spaces, special formatting characters and other special characters, or other characters,
(d) computer methods to analyze such terms, including their frequency of occurrence, location, order or formatting, in such materials, or in parts or portions of such materials,
(e) computer methods to develop a relevance index for such terms reflecting the relevance of such terms to the subject matter on which responders are to be evaluated, which may include some or all of the following
(A) a relevance index based on analysis of such first part and second part or parts of the materials the user provides, either or both of which parts may be subdivided into subunits, to determine the terms that provide the greatest separation of such parts, and/or of any such subunits, determined based on standard measures from the art of text classification, including but not limited to mutual information and chi squared measures, or
(B) a relevance index based on some or all of the following
(i) determination of the frequency of each term in each of the two or more parts of the materials, and
(ii) determination of the relevance index for each such term by multiplying the frequency of that term in the first part of the materials by a weight, which may include one of the following weights
(I) a weight equal to the logarithm, to the base two, of a fraction, the numerator of which is such frequency of the term in the first part of the materials, and the denominator of which is the frequency of that term in the second part or other parts of the materials, thus reducing such weight for the term to reflect the extent to which that term's frequency in the second part or other parts of the materials is higher,
(II) a weight otherwise based on a measure of the relative frequencies of that term in, or otherwise based on the relative importance of that term to, the first part of the materials and the second part or other parts of the materials,
(f) computer methods to rank such terms by such relevance index,
(g) methods for the user to review the terms in a list ranked by such relevance index,
(h) methods for the user to select from such list such terms as the user believes are appropriate upon which to base one or more, or all, of the tasks that individual responders will be instructed to perform, and/or
(i) methods for the user to derive from such terms concepts upon which to base such tasks.

12. The system and methods of claim [1] further including plagiarism testing methods provided to the user to compare different responders' responses to one or more of the same tasks, and, should the user choose to provides such materials, to compare such responses to outside materials related to the subject of such tasks, to determine statistically the probability that two or more responders have collaborated or otherwise plagiarized from each other, or that one or more responders have plagiarized from any such outside materials, in respect of providing their responses to such tasks, such plagiarism testing methods including some or all of the following
(a) computer methods for the user to select one or more probability distributions from a group of probability distributions, including in such group, without limitation, normal, lognormal, binomial, multinomial, exponential and Poisson probability distributions,
(b) computer methods providing means to use such probability distribution selected by the user to model probabilistically some or all of the following
(A) some or all of the terms occurring in the response or responses,
(B) some or all of the terms occurring in any such outside materials,
(C) the location, order or formatting of some or all of the terms in such responses, or
(D) the location, order or formatting of some or all of the terms in such outside materials,
(c) computer methods providing means to estimate statistically from the actual terms occurring in the responses, and in any such outside materials, the parameters of such probabilistic model based on the selected probability distributions, using standard statistical methodology well known in the art of constructing, estimating, validating and analyzing probabilistic models,
(d) computer methods providing means to determine, based on these estimates of such parameters of such probabilistic model, the probabilities of the similarity of some or all of the following
(A) one or more pairs of responses to each other, including the similarity of the responses' terms to each other, or
(B) one or more of the responses to any outside materials, including the similarity of the responses' terms to any such outside materials' terms,
including some or all of the terms' text, formatting, capitalization, location or order in such determination of similarity and probability of similarity,
(e) computer methods providing means to estimate statistically the confidence, or other statistical measure of likelihood or conviction, that such similarity among some or all of the pairs of responses, or among some or all of the responses and any outside materials, occurred randomly, or, in the alternative, did not occur randomly and thus that plagiarism occurred among such pairs of responses, or among such the responses and any outside materials, or
(f) computer methods to list for the user's review some or all of the pairs of responses to such tasks in order of the estimated probability, or of the statistical confidence or other statistical likelihood measure, that plagiarism occurred among such pairs of responses, or to list some or all of the responses in order of the probability, or of the statistical confidence or other statistical likelihood measure, that plagiarism occurred among such responses and any such outside materials.
